(19) United States
(12) Patent Application Publication
(10) Pub. No.: US 2026/0304163 A1
(43) Pub. Date: Oct. 1, 2026

(54) INTERMEDIARY BEAM FAILURE DETECTION CONDITIONS FOR PRE-BEAM-FAILURE ACTIONS

(71) Applicant: QUALCOMM Incorporated, San Diego, CA (US)

(72) Inventors: Doohyun SUNG, Basking Ridge, NJ (US); Jelena DAMNJANOVIC, Del Mar, CA (US); Sitaramanjaneyulu KANAMARLAPUDI, San Diego, CA (US)

(21) Appl. No.: 19/090,761

(22) Filed: Mar. 26, 2025

(51) Int. Cl. H04W 24/04; H04W 24/10

(52) U.S. Cl. CPC H04W 24/04; H04W 24/10

(57) ABSTRACT

Various aspects of the present disclosure generally relate to wireless communication. In some aspects, a user equipment (UE) may monitor one or more signal quality parameters associated with communications via a communication beam. The UE may obtain, in association with monitoring the one or more signal quality parameters, a beam failure instance indication associated with the communication beam. The UE may increment, in accordance with obtaining the beam failure instance indication, a failure event counter from a first value to a second value, wherein the second value is less than or equal to a beam failure detection threshold and greater than or equal to a monitoring threshold. The UE may perform an action in accordance with the second value satisfying a beam failure threshold of a set of one or more beam failure thresholds. Numerous other aspects are described.

### FIELD OF THE DISCLOSURE

Aspects of the present disclosure generally relate to wireless communication and specifically relate to techniques, apparatuses, and methods associated with intermediary beam failure detection conditions for pre-beam-failure actions.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

A user equipment (UE) may communicate with a network node via one or more wireless communication beams or beam pairs. For example, the network node and the UE may establish a communication link or beam pair, and otherwise increase reliability, throughput, signal strength, or other signal properties for communications, by performing one or more beam management operations, such beam failure detection (BFD) and/or beam failure recovery. In BFD, a UE may monitor communications between the UE and the network node to assess whether one or more beam failure trigger conditions are satisfied. The UE may determine whether the one or more beam failure trigger conditions are satisfied by checking whether one or more parameters, such as a physical downlink control channel (PDCCH) block error rate (BLER), reference signal received power (RSRP), or signal-to-noise ratio (SNR), among other examples, fall below a target value for the communications, or by identifying that a timer associated with beam failure instance detection has expired. When the one or more parameters fall below the target, the UE may increment a beam failure instance counter and may trigger a beam failure recovery request (BFRQ) transmission (e.g., to initiate or request a beam failure recovery procedure) if the beam failure instance counter equals or exceeds a threshold quantity of beam failure instances within a duration associated with a beam failure detection timer.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to monitor one or more signal quality parameters associated with communications via a communication beam. The processing system may be configured to cause the UE to obtain, in association with monitoring the one or more signal quality parameters, a beam failure instance indication associated with the communication beam. The processing system may be configured to cause the UE to increment, in accordance with obtaining the beam failure instance indication, a failure event counter from a first value to a second value, wherein the second value is less than or equal to a beam failure detection threshold and greater than or equal to a monitoring threshold. The processing system may be configured to cause the UE to perform an action in accordance with the second value satisfying a beam failure threshold of a set of one or more beam failure thresholds.

Some aspects described herein relate to a network node. The network node may include a processing system. The processing system may include one or more processors and one or more code-storing memories coupled with the one or more processors. The processing system may be configured to cause the network node to transmit, to a UE, control signaling indicating a set of one or more pre-beam-failure actions. The processing system may be configured to cause the network node to monitor one or more signal quality parameters associated with communications via a communication beam. The processing system may be configured to cause the network node to perform an action of the set of one or more pre-beam-failure actions in association with a beam failure threshold, of a set of one or more beam failure thresholds, being satisfied, wherein a failure event counter associated with the communication beam being incremented from a first value that is less than or equal to a beam failure detection threshold to a second value that is greater than or equal to a monitoring threshold.

Some aspects described herein relate to a method of wireless communication performed by a UE. The method may include monitoring one or more signal quality parameters associated with communications via a communication beam. The method may include obtaining, in association with monitoring the one or more signal quality parameters, a beam failure instance indication associated with the communication beam. The method may include incrementing, in accordance with obtaining the beam failure instance indication, a failure event counter from a first value to a second value, wherein the second value is less than or equal to a beam failure detection threshold and greater than or equal to a monitoring threshold. The method may include performing an action in accordance with the second value satisfying a beam failure threshold of a set of one or more beam failure thresholds.

Some aspects described herein relate to a method of wireless communication performed by a network node. The method may include transmitting, to a UE, control signaling indicating a set of one or more pre-beam-failure actions. The method may include monitoring one or more signal quality parameters associated with communications via a communication beam. The method may include performing an action of the set of one or more pre-beam-failure actions in association with a beam failure threshold, of a set of one or more beam failure thresholds, being satisfied, wherein a failure event counter associated with the communication beam being incremented from a first value that is less than or equal to a beam failure detection threshold to a second value that is greater than or equal to a monitoring threshold.

Some aspects described herein relate to a non-transitory computer-readable medium that stores a set of instructions for wireless communication by a UE. The set of instructions, when executed by one or more processors of the UE, may cause the UE to monitor one or more signal quality parameters associated with communications via a communication beam. The set of instructions, when executed by one or more processors of the UE, may cause the UE to obtain, in association with monitoring the one or more signal quality parameters, a beam failure instance indication associated with the communication beam. The set of instructions, when executed by one or more processors of the UE, may cause the UE to increment, in accordance with obtaining the beam failure instance indication, a failure event counter from a first value to a second value, wherein the second value is less than or equal to a beam failure detection threshold and greater than or equal to a monitoring threshold. The set of instructions, when executed by one or more processors of the UE, may cause the UE to perform an action in accordance with the second value satisfying a beam failure threshold of a set of one or more beam failure thresholds.

Some aspects described herein relate to a non-transitory computer-readable medium that stores a set of instructions for wireless communication by a network node. The set of instructions, when executed by one or more processors of the network node, may cause the network node to transmit, to a UE, control signaling indicating a set of one or more pre-beam-failure actions. The set of instructions, when executed by one or more processors of the network node, may cause the network node to monitor one or more signal quality parameters associated with communications via a communication beam. The set of instructions, when executed by one or more processors of the network node, may cause the network node to perform an action of the set of one or more pre-beam-failure actions in association with a beam failure threshold, of a set of one or more beam failure thresholds, being satisfied, wherein a failure event counter associated with the communication beam being incremented from a first value that is less than or equal to a beam failure detection threshold to a second value that is greater than or equal to a monitoring threshold.

Some aspects described herein relate to an apparatus for wireless communication. The apparatus may include means for monitoring one or more signal quality parameters associated with communications via a communication beam. The apparatus may include means for obtaining, in association with monitoring the one or more signal quality parameters, a beam failure instance indication associated with the communication beam. The apparatus may include means for incrementing, in accordance with obtaining the beam failure instance indication, a failure event counter from a first value to a second value, wherein the second value is less than or equal to a beam failure detection threshold and greater than or equal to a monitoring threshold. The apparatus may include means for performing an action in accordance with the second value satisfying a beam failure threshold of a set of one or more beam failure thresholds.

Some aspects described herein relate to an apparatus for wireless communication. The apparatus may include means for transmitting, to a UE, control signaling indicating a set of one or more pre-beam-failure actions. The apparatus may include means for monitoring one or more signal quality parameters associated with communications via a communication beam. The apparatus may include means for performing an action of the set of one or more pre-beam-failure actions in association with a beam failure threshold, of a set of one or more beam failure thresholds, being satisfied, wherein a failure event counter associated with the communication beam being incremented from a first value that is less than or equal to a beam failure detection threshold to a second value that is greater than or equal to a monitoring threshold.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating examples of beam management procedures.

FIG. 4 is a diagram illustrating an example of an artificial intelligence or machine-learning (AI/ML)-based beam management procedure.

FIG. 5 is a diagram illustrating an example of AI/ML-based beam management.

FIG. 6 is a diagram illustrating an example of beam failure detection.

FIG. 7 is a diagram of an example associated with intermediary beam failure detection (BFD) conditions for pre-beam-failure actions or procedures.

FIG. 8 is a diagram illustrating an example of a BFD procedure including at least one warning state.

FIG. 9 is a diagram illustrating an example of a failure event counter that is incremented through multiple intermediary states.

FIG. 10A is a diagram illustrating an example of a global event counter that is decremented to a monitoring state.

FIG. 10B is a diagram illustrating an example of a global event counter that is decremented to a warning state.

FIG. 11 is a diagram illustrating an example process performed, for example, at a user equipment (UE) or an apparatus of a UE.

FIG. 12 is a diagram illustrating an example process performed, for example, at a network node or an apparatus of a network node.

FIG. 13 is a diagram of an example apparatus for wireless communication.

FIG. 14 is a diagram of an example apparatus for wireless communication.

### DETAILED DESCRIPTION

A user equipment (UE) may communicate with a network node via one or more wireless communication beams or beam pairs. For example, the network node and the UE may establish a communication link or beam pair, and otherwise increase reliability, throughput, signal strength, or other signal properties for communications, by performing one or more beam management operations, such as beam failure detection (BFD), in which a communication beam is no longer suitable for communications between the UE and the network node, and/or beam failure recovery (BFR), in which the UE and the network node perform one or more operations to make the communication beam, or select another communication beam that is, suitable for the communications. In BFD, a UE may monitor communications between the UE and the network node to assess whether one or more beam failure trigger conditions are satisfied. The UE may determine whether the one or more beam failure trigger conditions are satisfied by checking whether one or more parameters, such as a physical downlink control channel (PDCCH) block error rate (BLER), reference signal received power (RSRP), or signal-to-noise ratio (SNR), among other examples, fall below a target value for the communications, or by identifying that a timer associated with beam failure instance (BFI) detection has expired. When the one or more parameters fall below the target, the UE may increment a BFI counter and may trigger a beam failure recovery request (BFRQ) transmission (e.g., to initiate or request a BFR procedure) if the BFI counter equals or exceeds a threshold quantity of BFIs within a duration associated with a beam failure detection timer. The BFI counter equaling or exceeding a threshold quantity of BFIs within the duration may be associated with a beam failure event occurrence or may indicate that a beam failure event has occurred.

When a beam failure event occurs (e.g., the BFI counter satisfies a threshold, or a BFD timer expires, or both, among other examples), the UE or the network node may initiate or perform a beam recovery procedure. In BFD, the UE may be operating in a monitoring state in which parameters are monitored by the UE to identify BFIs, or the UE may be operating in a beam failure detected state in which the UE has identified a beam failure event and is performing one or more operations as part of BFR. Each beam recovery procedure may include a random access procedure, among other examples, which can be a resource intensive procedure. As a result, a beam recovery procedure may take a relatively long time, may use a large quantity of time, frequency, and/or processing resources, or may cause relatively long communication delays, and thus service quality or user experience may be degraded.

Various aspects relate generally to a BFD procedure including one or more intermediary BFD states (e.g., one or more warning states in which a count of the BFI counter is greater than zero and less than the BFI threshold for declaring beam failure). Some aspects more specifically relate to actions or procedures associated with each warning state. In some aspects, the UE (e.g., operating in a monitoring state) may monitor one or more signal quality parameters of communications performed via or associated with a communication beam. The UE may obtain a BFI indication in accordance with at least one signal quality parameter falling below a target or satisfying a threshold, or in accordance with a timer expiring. The UE may increment a BFI counter to account for the obtained BFI indication and may enter a warning state based on the value of the BFI counter. The UE may perform one or more actions associated with the warning state to mitigate degradation of the communication beam.

Additional aspects may relate to artificial intelligence or machine learning (AI/ML)-based BFD event prediction. For example, the UE may use an AI/ML model to predict parameters associated with a beam failure event or to predict a likelihood that a beam failure event will occur. In some aspects, entering a warning state may be associated with a predicted likelihood of a beam failure event occurring during a future time period. In some aspects, the one or more actions may include communicating a measurement report, initiating AI/ML predictions associated with BFD, communicating a report including one or more AI/ML predictions or inferences associated with a predicted BFD event, communicating a BFD status report, or performing a conditional cell switch procedure, among other examples.

Particular aspects of the subject matter described in this disclosure can be implemented to realize one or more of the following potential advantages. In some examples, the described techniques can be used to decrease latency and enhance user experience. By the UE performing an action associated with the warning state, the UE may prevent full beam failure and avoid lengthy beam failure recovery procedures by performing one or more measures to mitigate beam degradation and avoid total beam failure or a resulting beam failure recovery procedure. For example, by the UE and the network node communicating a measurement report or an inference report, the UE and the network node may communicate information that may inform one or more subsequent beam management operations or may indicate to the network node that the UE has entered a warning state or that a BFR is likely to be initiated.

By the UE initiating AI/ML predictions based on entering a warning state, the UE may conserve energy that would otherwise be expended to generate AI/ML predictions while operating in a state in which beam failure is less likely to occur. By the UE performing a conditional cell switch procedure, the UE may avoid beam failure and may conserve time and resources that would otherwise be used to perform a BFR procedure. By the UE communicating a predicted beam failure event, the UE may mitigate resource expenditure by the UE, or the network node, or both, by preempting the event and triggering one or more preparatory actions.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

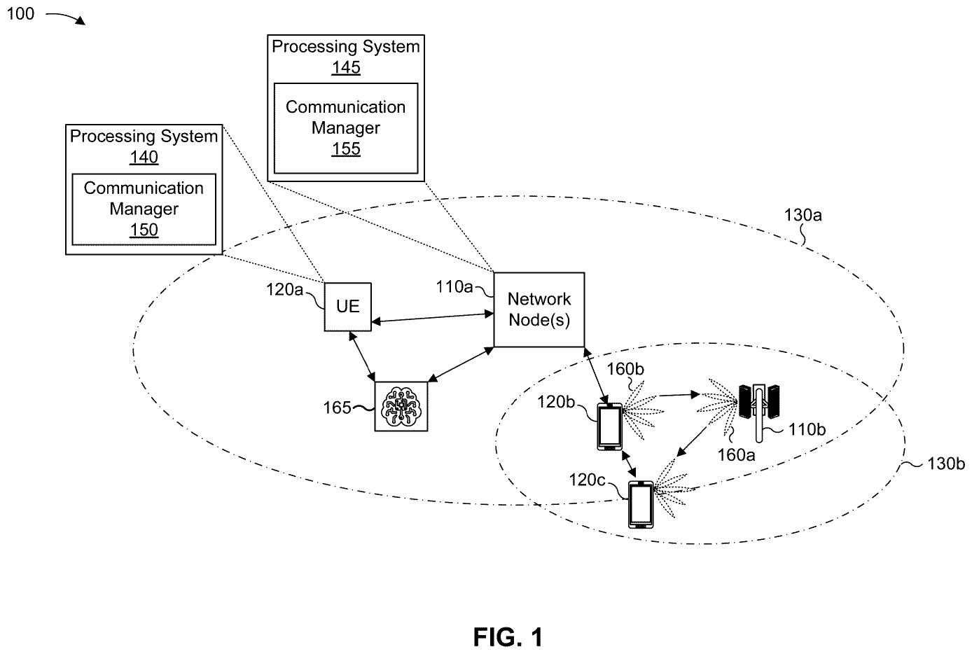

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

Further efficiencies in throughput, signal strength, or other signal properties may be achieved through beam refinement. For example, the network node 110 may be capable of communicating with the UE 120 using beams (for example, beam(s) 160a) of different beam widths. In some examples, the network node 110 may be configured to utilize a wider beam to communicate with the UE 120 when the UE 120 is in motion or for initial beam acquisition because wider coverage may increase the likelihood that the mobile UE 120 remains in coverage of the network node 110 while communicating using the wider beam. Conversely, the network node 110 may use a narrower beam to communicate with the UE 120 when the UE 120 is stationary because the network node 110 can reliably focus coverage on the UE 120 with low or minimal likelihood of the UE 120 moving out of the coverage area of the narrower beam. In some examples, to select a particular beam (for example, from the beam(s) 160a) for communication with a UE 120, the network node 110 may transmit a reference signal, such as an SSB or a CSI-RS, on each of a plurality of beams in a beam-sweeping manner. In some examples, SSBs may be transmitted on wider beams, whereas CSI-RSs may be transmitted on narrower beams. The UE 120 may measure the RSRP or the signal-to-interference-plus-noise ratio (SINR) on each of the beams and transmit a beam measurement report (for example, an L1 measurement report) to the network node 110 indicating the RSRP or SINR associated with each of one or more of the measured beams. The network node 110 may then select the particular beam for communication with the UE 120 based on the L1 measurement report. In some other examples, when there is channel reciprocity between the uplink and the downlink, the network node 110 may derive the particular beam to communicate with the UE 120 (for example, on both the uplink and downlink) based on uplink measurements of one or more uplink reference signals, such as an SRS, transmitted by the UE 120.

One enhancement for multi-beam operation at higher carrier frequencies is facilitation of efficient (for example, low latency and low overhead) downlink or uplink beam management operations to support Layer 1 or Layer 2 (L1/L2)-centric inter-cell mobility. L1/L2 signaling may be referred to as “lower layer” signaling. L1/L2 signaling may be used to activate or deactivate candidate cells in a set of cells configured for lower layer triggered mobility (LTM) or to provide reference signals for measurement by the UE 120, by which the UE 120 may select a candidate beam as a target beam for a lower layer handover operation. Accordingly, L1/L2-centric inter-cell mobility may enable a UE 120 to perform a cell switch via dynamic control signaling at lower layers (for example, DCI for L1 signaling or a MAC-CE for L2 signaling), rather than semi-static Layer 3 (L3) RRC signaling. Thus, L1/L2 centric inter-cell mobility may reduce latency, reduce overhead, or otherwise increase efficiency of the cell switch.

In some aspects, the UE 120 may include a communication manager 150. As described in more detail elsewhere herein, the communication manager 150 may monitor one or more signal quality parameters associated with communications via a communication beam; obtain, in association with monitoring the one or more signal quality parameters, a BFI indication associated with the communication beam; increment, in accordance with obtaining the BFI indication, a failure event counter from a first value to a second value, wherein the second value is less than or equal to a beam failure detection threshold and greater than or equal to a monitoring threshold; and perform an action in accordance with the second value satisfying a beam failure threshold of a set of one or more beam failure thresholds. Additionally, or alternatively, the communication manager 150 may perform one or more other operations described herein.

In some aspects, the network node 110 may include a communication manager 155. As described in more detail elsewhere herein, the communication manager 155 may transmit, to the UE 120, control signaling indicating a set of one or more pre-beam-failure actions; monitor one or more signal quality parameters associated with communications via a communication beam; and perform an action of the set of one or more pre-beam-failure actions in association with a beam failure threshold, of a set of one or more beam failure thresholds, being satisfied, wherein a failure event counter associated with the communication beam being incremented from a first value that is less than or equal to a beam failure detection threshold to a second value that is greater than or equal to a monitoring threshold. Additionally, or alternatively, the communication manager 155 may perform one or more other operations described herein.

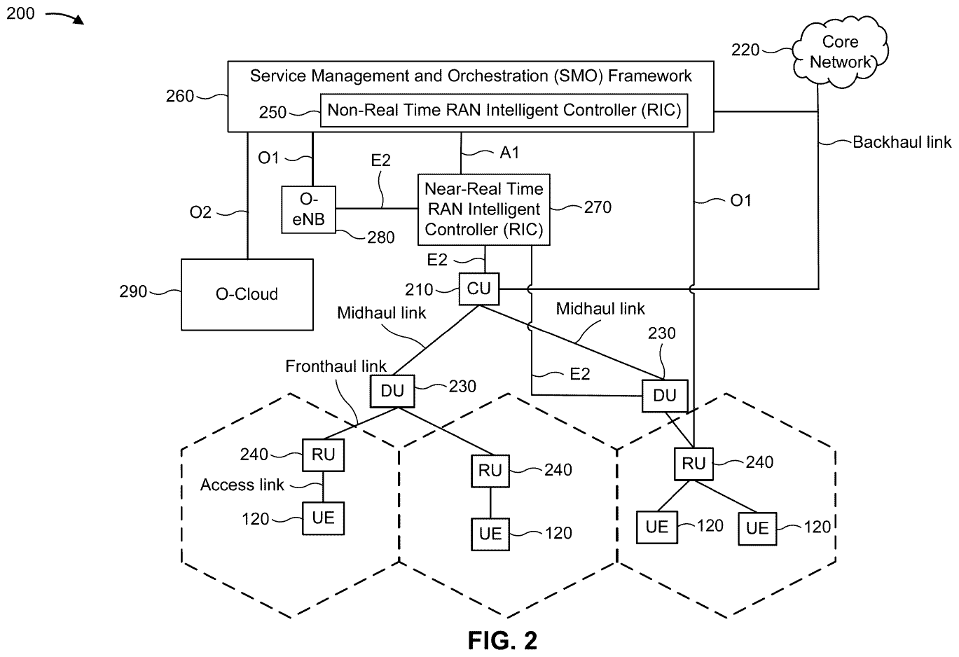

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

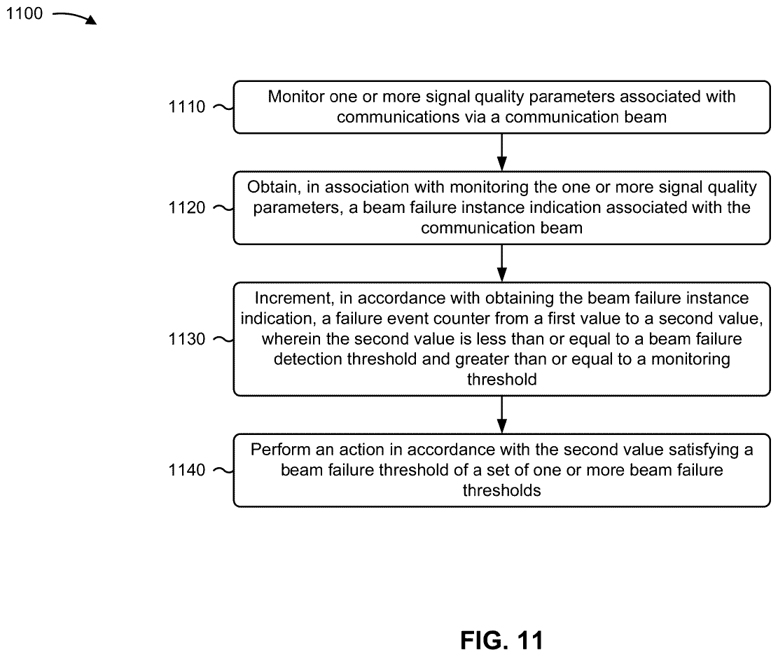

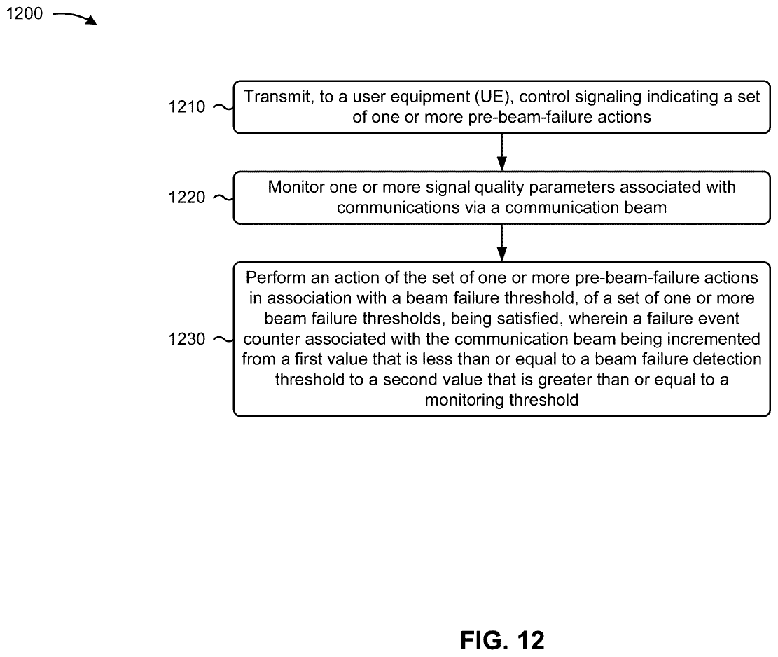

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with a BFD procedure including one or more intermediary BFD states (e.g., one or more warning states in which a count of the BFI counter is greater than zero and less than the BFI threshold for declaring beam failure), as described in more detail elsewhere herein. For example, the processing system 145 of the network node 110, the processing system 140 of the UE 120, the CU 210, the DU 230, or the RU 240 may perform or direct operations of, for example, process 1100 of FIG. 11, process 1200 of FIG. 12, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1100 of FIG. 11, process 1200 of FIG. 12, or other processes as described herein. In some examples, executing instructions may include running the instructions, converting the instructions, compiling the instructions, or interpreting the instructions, among other examples.

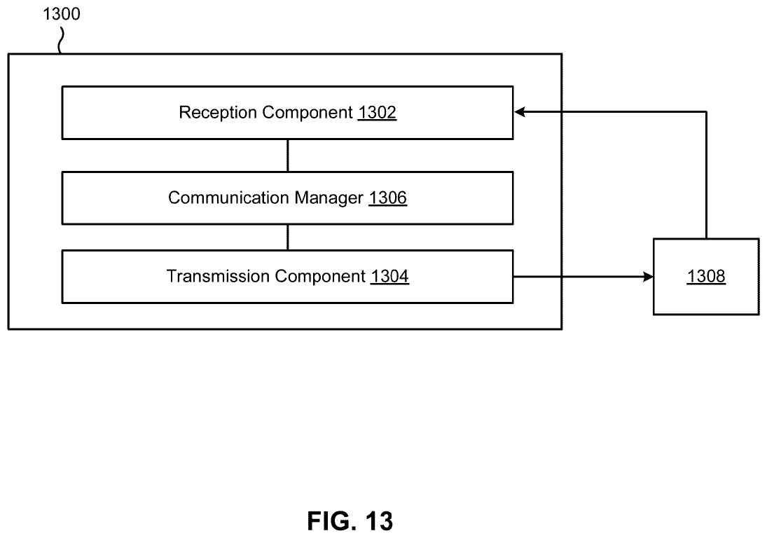

In some aspects, the UE 120 includes means for monitoring one or more signal quality parameters associated with communications via a communication beam; means for obtaining, in association with monitoring the one or more signal quality parameters, a BFI indication associated with the communication beam; means for incrementing, in accordance with obtaining the BFI indication, a failure event counter from a first value to a second value, wherein the second value is less than or equal to a beam failure detection threshold and greater than or equal to a monitoring threshold; or means for performing an action in accordance with the second value satisfying a beam failure threshold of a set of one or more beam failure thresholds. The means for the UE 120 to perform operations described herein may include, for example, one or more of communication manager 150, processing system 140, a radio, one or more RF chains, one or more transceivers, one or more antennas, one or more modems, a reception component (for example, reception component 1302 depicted and described in connection with FIG. 13), or a transmission component (for example, transmission component 1304 depicted and described in connection with FIG. 13), among other examples.

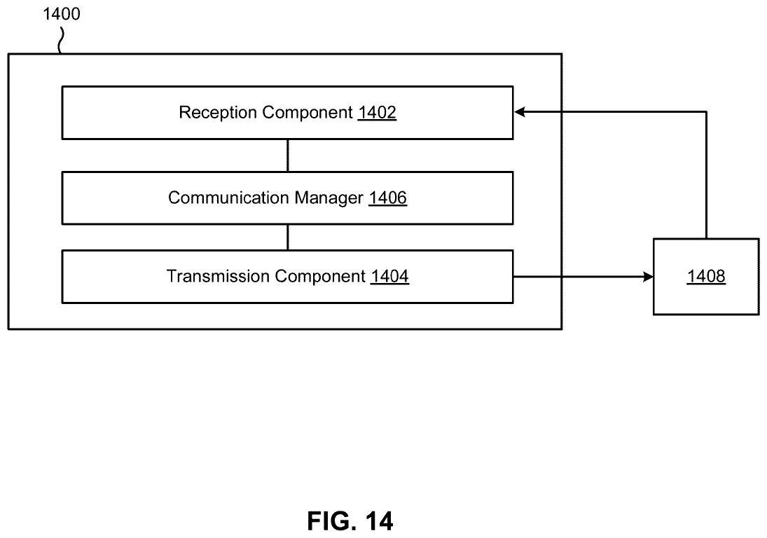

In some aspects, the network node 110 includes means for transmitting, to a UE 120, control signaling indicating a set of one or more pre-beam-failure actions; means for monitoring one or more signal quality parameters associated with communications via a communication beam; or means for performing an action of the set of one or more pre-beam-failure actions in association with a beam failure threshold, of a set of one or more beam failure thresholds, being satisfied, wherein a failure event counter associated with the communication beam being incremented from a first value that is less than or equal to a beam failure detection threshold to a second value that is greater than or equal to a monitoring threshold. The means for the network node 110 to perform operations described herein may include, for example, one or more of communication manager 155, processing system 145, a radio, one or more RF chains, one or more transceivers, one or more antennas, one or more modems, a reception component (for example, reception component 1402 depicted and described in connection with FIG. 14), or a transmission component (for example, transmission component 1404 depicted and described in connection with FIG. 14), among other examples.

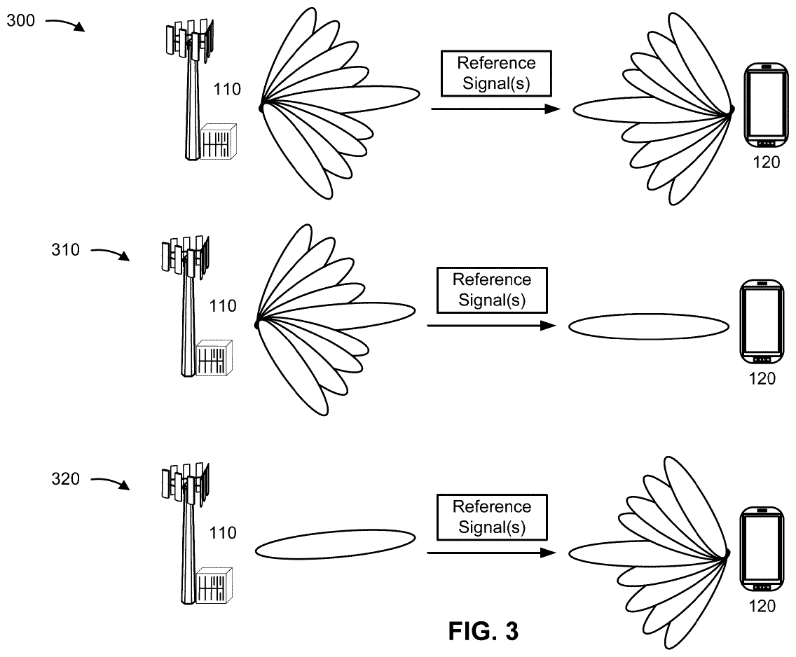

FIG. 3 is a diagram illustrating examples 300, 310, and 320 of beam management procedures. As shown in FIG. 3, examples 300, 310, and 320 include a UE 120 in communication with a network node 110 in a wireless network (e.g., wireless network 100). However, the devices shown in FIG. 3 are provided as examples, and the wireless network may support communication and beam management between other devices (e.g., between a UE 120 and a network node 110 or transmit receive point (TRP), between a mobile termination node and a control node, between an integrated access and backhaul (IAB) child node and an IAB parent node, or between a scheduled node and a scheduling node). In some aspects, the UE 120 and the network node 110 may be in a connected state (e.g., an RRC connected state).

As shown in FIG. 3, example 300 may include a network node 110 (e.g., one or more network node devices such as an RU, a DU, or a CU, among other examples) and a UE 120 communicating to perform beam management using one or more reference signals. Example 300 depicts a first beam management procedure (e.g., P1 beam management). The first beam management procedure may be referred to as a beam selection procedure, an initial beam acquisition procedure, a beam sweeping procedure, a cell search procedure, or a beam search procedure. As shown in FIG. 3 and example 300, reference signals may be configured to be transmitted from the network node 110 to the UE 120. The one or more reference signals may be configured to be periodic (e.g., using RRC signaling), semi-persistent (e.g., using media access control (MAC) control element (MAC-CE) signaling), or aperiodic (e.g., using DCI).

The first beam management procedure may include the network node 110 performing beam sweeping over multiple transmit (Tx) beams. The network node 110 may transmit a reference signal using each transmit beam for beam management. To enable the UE 120 to perform receive (Rx) beam sweeping, the network node may use a transmit beam to transmit (e.g., with repetitions) each reference signal at multiple times within the same resource set so that the UE 120 can sweep through receive beams in multiple transmission instances. For example, if the network node 110 has a set of N transmit beams and the UE 120 has a set of M receive beams, the reference signal may be transmitted on each of the N transmit beams M times so that the UE 120 may receive M instances of the reference signal per transmit beam. In other words, for each transmit beam of the network node 110, the UE 120 may perform beam sweeping through the receive beams of the UE 120. As a result, the first beam management procedure may enable the UE 120 to measure a reference signal on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 300 has been described in connection with reference signals in general, the first beam management process may use CSI-RSs or SSBs for beam management in a similar manner as described above.

As shown in FIG. 3, example 310 may include a network node 110 and a UE 120 communicating to perform beam management using one or more reference signals. Example 310 depicts a second beam management procedure (e.g., P2 beam management). The second beam management procedure may be referred to as a beam refinement procedure, a network node beam refinement procedure, a TRP beam refinement procedure, or a transmit beam refinement procedure. As shown in FIG. 3 and example 310, one or more reference signals may be configured to be transmitted from the network node 110 to the UE 120. The one or more reference signals may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a reference signal using each transmit beam of the one or more transmit beams for beam management. The UE 120 may measure each reference signal using a single (e.g., a same) receive beam (e.g., determined based at least in part on measurements performed in connection with the first beam management procedure). The second beam management procedure may enable the network node 110 to select a best transmit beam based at least in part on measurements of the one or more reference signals (e.g., measured by the UE 120 using the single receive beam) reported by the UE 120.

As shown in FIG. 3, example 320 depicts a third beam management procedure (e.g., P3 beam management). The third beam management procedure may be referred to as a beam refinement procedure, a UE beam refinement procedure, or a receive beam refinement procedure. As shown in FIG. 3 and example 320, one or more reference signals may be configured to be transmitted from the network node 110 to the UE 120. The one or more reference signals may be configured to be aperiodic (e.g., using DCI). The third beam management process may include the network node 110 transmitting the one or more reference signals using a single transmit beam (e.g., determined based at least in part on measurements reported by the UE 120 in connection with the first beam management procedure or the second beam management procedure). To enable the UE 120 to perform receive beam sweeping, the network node may use a transmit beam to transmit (e.g., with repetitions) a reference signal at multiple times within the same resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure or the second beam management procedure). The third beam management procedure may enable the network node 110 or the UE 120 to select a best receive beam based at least in part on reported measurements received from the UE 120 (e.g., of the reference signal of the transmit beam using the one or more receive beams). Based on performing one or more of the beam management processes shown in examples 300, 310, and 320, respectively, the UE 120 or the network node 110 or both may perform BFD. For example, in association with the selection of a communication beam (e.g., a receive beam, a transmit beam), the UE 120 may monitor one or more quality parameters associated with communications vis the communication beam. For example, UEs 120 having high mobility may experience degraded communication quality, and thus a UE may monitor whether a communication beam is performing sufficiently such that the UE 120 may initiate a BFR procedure when communications via the selected beam are no longer meeting quality standards.

As indicated above, FIG. 3 is provided as an example of beam management procedures. Other examples of beam management procedures may differ from what is described with respect to FIG. 3. For example, the UE 120 and the network node 110 may perform the third beam management procedure before performing the second beam management procedure, or the UE 120 and the network node 110 may perform a similar beam management procedure to select a UE transmit beam.

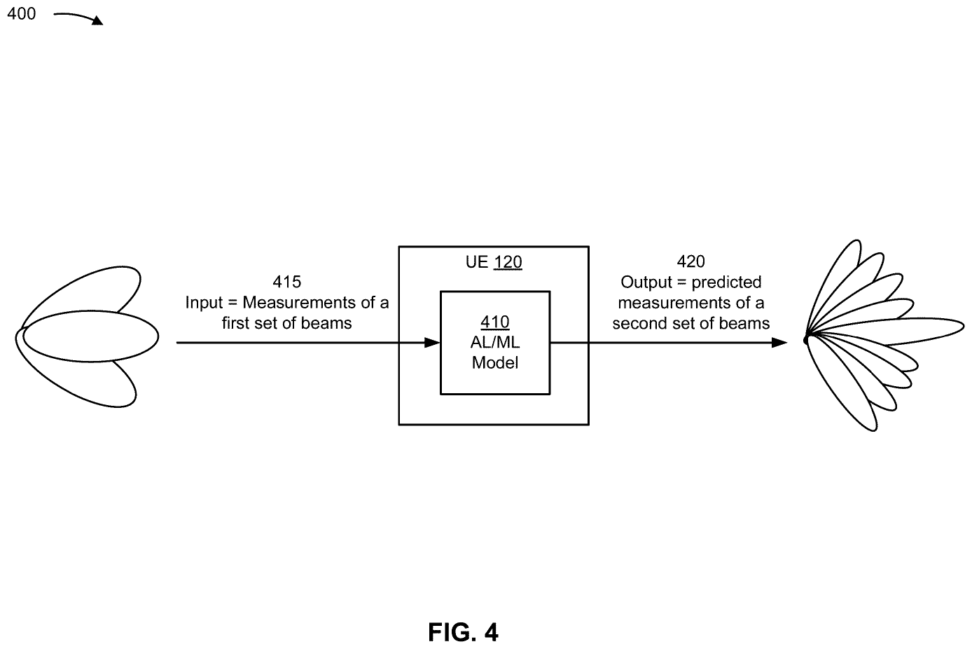

FIG. 4 is a diagram illustrating an example 400 of an AI/ML-based beam management procedure. As shown in FIG. 4, an AI/ML model 410 may be deployed at or on a UE 120. For example, a model inference host (such as a model inference host) may be deployed at, or on, a UE 120. The AI/ML model 410 may enable the UE 120 to determine one or more inferences or predictions based on data input to the AI/ML model 410.

For example, as shown by reference number 415, an input to the AI/ML model 410 may include measurements associated with a first set of beams. For example, a network node 110 may transmit one or more signals using respective beams from the first set of beams. The UE 120 may perform measurements (e.g., L1 RSRP measurements or other measurements) of the first set of beams to obtain a first set of measurements. For example, each beam, from the first set of beams, may be associated with one or more measurements performed by the UE 120. The UE 120 may input the first set of measurements (e.g., L1 RSRP measurement values) into the AI/ML model 410 along with information associated with the first set of beams or a second set of beams, such as a beam direction (e.g., spatial direction), beam width, beam shape, or other characteristics of the respective beams from the first set of beams or the second set of beams.

As shown by reference number 420, the AI/ML model 410 may output one or more predictions. The one or more predictions may include predicted measurement values (e.g., predicted L1 RSRP measurement values) associated with the second set of beams. This may reduce a quantity of beam measurements that are performed by the UE 120, thereby conversing power of the UE 120 or network resources that would have otherwise been used to measure all beams included in the first set of beams and the second set of beams. This type of prediction may be referred to as a codebook based spatial domain selection or prediction.

In some aspects, the predicted measurement values may be used to perform BFD. For example, the AI/ML model 410 may output a beam failure event prediction.

As another example, an output of the AI/ML model 410 may include a point-direction, an angle of departure (AoD), or an angle of arrival (AoA) of a beam included in the second set of beams. This type of prediction may be referred to as a non-codebook based spatial domain selection or prediction. As another example, multiple measurement report or values, collected at different points in time, may be input to the AI/ML model 410. This may enable the AI/ML model 410 to output codebook based or non-codebook based predictions for a measurement value, an AoD, or an AoA, among other examples, of a beam at a future time. The output(s) of the AI/ML model 410, as described herein, may facilitate initial access procedures, secondary cell group (SCG) setup procedures, beam refinement procedures (e.g., a P2 beam management procedure or a P3 beam management procedure), link quality or interference adaptation procedure, beam failure or beam blockage predictions, or radio link failure predictions, among other examples.

In some examples, the first set of beams may be referred to as Set B beams and the second set of beams may be referred to as Set A beams. In some examples, the first set of beams (e.g., the Set B beams) may be a subset of the second set of beams (e.g., the Set A beams). In some other examples, the first set of beams and the second set of beams may be different beams or may be mutually exclusive sets. For example, the first set of beams (e.g., the Set B beams) may include wide beams (e.g., unrefined beams or beams having a beam width that satisfies a first threshold) and the second set of beams (e.g., the Set A beams) may include narrow beams (e.g., refined beams or beams having a beam width that satisfies a second threshold). In one example, the AI/ML model 410 may perform spatial-domain beam predictions for beams included in the Set A beams based on measurement results of beams included in the Set B beams. As another example, the AI/ML model 410 may perform temporal beam prediction for beams included in the Set A beams based on historic measurement results of beams included in the Set B beams.

As indicated above, FIG. 4 is provided as an example. Other examples may differ from what is described with regard to FIG. 4.

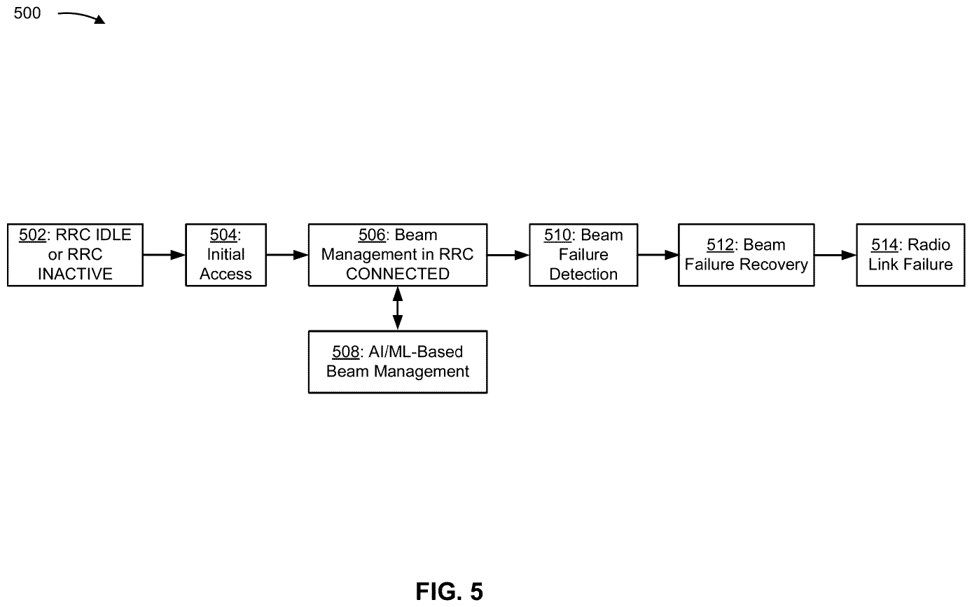

FIG. 5 is a diagram illustrating an example 500 of beam management.

As shown by reference number 502, a UE may initially be in an RRC idle state or an RRC inactive state. As shown by reference number 504, the UE may perform an initial access. As shown by reference number 506, the UE may perform a beam management after entering an RRC connected state. The beam management may include P1, P2, and/or P3 beam management procedures. The P1 beam management procedure may be a beam selection procedure, an initial beam acquisition procedure, a beam sweeping procedure, a cell search procedure, and/or a beam search procedure. The P2 beam management procedure may be a beam refinement procedure, a network node beam refinement procedure, a TRP beam refinement procedure, and/or a transmit (Tx) beam refinement procedure. The P3 beam management procedure may be a beam refinement procedure, a UE beam refinement procedure, and/or an Rx beam refinement procedure. As shown by reference number 508, the UE may also perform beam management using an AI/ML-based approach. The beam management using the AI/ML-based approach may use an AI/ML model in a spatial domain (SD), a time domain (TD), and/or a frequency domain (FD), which may reduce signaling overhead and latency and improve a beam selection accuracy. The AI/ML model may be associated with a lifecycle management, which may involve a model training, model deployment, model inference, model monitoring, and/or model updating. As shown by reference number 510, the UE may perform BFD, which may be based at least in part on measurements obtained during the AI/ML-based beam management after entering the RRC connected mode. A UE supporting BFD may operate in a monitoring state in which the UE obtains measurements, or a beam failure detected state in which BFR is initiated.

For AI/ML-based beam management, a first beam management example, or a second beam management example, or both examples may be supported for characterization and baseline performance evaluations. The first beam management example may involve a spatial domain downlink beam prediction for a first set of beams (Set A) based at least in part on measurement results of a second set of beams (Set B). The second beam management example may involve a temporal downlink beam prediction for the first set of beams based at least in part on historical measurement results of the second set of beams. For the first beam management example and the second beam management example, beams in the first set of beams and beams in the second set of beams may be in the same frequency range.

In the first beam management example, in a first alternative, the second set of beams may be a subset of the first set of beams. In the first alternative, the first set of beams and the second set of beams may each be associated with a defined quantity of beams. The second set of beams may be determined from beams in the first set of beams based at least in part on a fixed pattern or a random pattern. In a second alternative, the first set of beams may be different from the second set of beams (e.g., the first set of beams may include narrow beams and the second set of beams may include wide beams). In the second alternative, the first set of beams and the second set of beams may each be associated with a defined quantity of beams. A quasi co-location (QCL) relation may be defined between beams in the first set of beams and beams in the second set of beams. Further, the first set of beams may be for downlink beam prediction, and the second set of beams may be for downlink beam measurement.

For the first beam management example and with a UE-side AI/ML model, L1 signaling may be used to report information associated with an AI/ML model inference to a network node. The information may indicate one or more beams (e.g., reported beams) that are based at least in part on an output of the AI/ML model inference. The information may indicate predicted L1-RSRP measurements corresponding to the one or more beams.

For the second beam management example and with the UE-side AI/ML model, L1 signaling may be used to report information associated with the AI/ML model inference to the network node. The information may indicate one or more beams of N future time instances, where the one or more beams may be based at least in part on the output of the AI/ML model inference. A value for N may be defined. The information may indicate predicted L1-RSRP measurements corresponding to the one or more beams. The information may indicate a timestamp corresponding to the one or more beams, where the timestamp may be indicated explicitly or implicitly.

For the first and second beam management examples with the UE-side AI/ML model, a model monitoring may be employed. For a UE-side model monitoring, the UE may monitor performance metrics. The UE may perform decisions of model selection, activation, deactivation, switching, or fallback operation based at least in part on the performance metrics. For a network-side model monitoring, the network node may monitor performance metrics. The network node may perform decisions of model selection, activation, deactivation, switching, or fallback operation based at least in part on the performance metrics. In a hybrid model monitoring, the UE may monitor performance metrics, and the network node may perform decisions of model selection, activation, deactivation, switching, or fallback operation based at least in part on the performance metrics.

For the first and second beam management examples with a network-side AI/ML model, the network-side model monitoring may be employed. The network node may monitor the performance metrics, and the network node may perform decisions of model selection, activation, deactivation, switching, or fallback operation based at least in part on the performance metrics. For the first and second beam management examples with the network-side AI/ML model, a beam measurement and report for model monitoring may be employed. For the first and second beam management examples with the network-side AI/ML model, the UE may report measurement results of more than four beams in one reporting instance based at least in part on an L1 beam reporting for the AI/ML model inference.

In BFD, the UE may monitor one or more reference signals (e.g., as described with reference to FIG. 3) to assess whether a beam failure trigger condition is satisfied. The UE may determine, at L1, whether the beam failure trigger condition is satisfied by checking whether a PDCCH BLER falls below a target for the one or more reference signals. When the PDCCH BLER falls below the target, layer 2 (L2) may be informed of a BFI regarding the serving cell. For example, L1 may inform L2 of the BFI.

As shown by reference number 512, the UE may perform a beam failure recovery (BFR) based at least in part on the BFD performed at least partially while operating in the monitoring state. For example, the UE, via L2, may trigger a BFRQ transmission after L2 receives, from L1, a quantity of BFIs within a duration (e.g., a particular, indicated, or defined duration). The quantity of BFIs may be RRC-configured via a BFI maximum count (beamFailureInstanceMaxCount). The duration may be RRC-configured via a beam failure detection timer (beamFailureDetectionTimer).

Each beam failure recovery procedure may include a random access procedure, among other examples, which can be a resource intensive procedure (e.g., may consume time, frequency, or processing resources in excess of baseline operating consumption). As a result, a BFR procedure may take a relatively long time, may use a large quantity of time, frequency, and/or processing resources, or may cause relatively long communication delays, and thus service quality or user experience may be degraded as a result.

As shown by reference number 514, when the BFR is not successful, the UE may declare a radio link failure (RLF) which may cause further consumption of resources.

As indicated above, FIG. 5 is provided as an example. Other examples may differ from what is described with regard to FIG. 5.

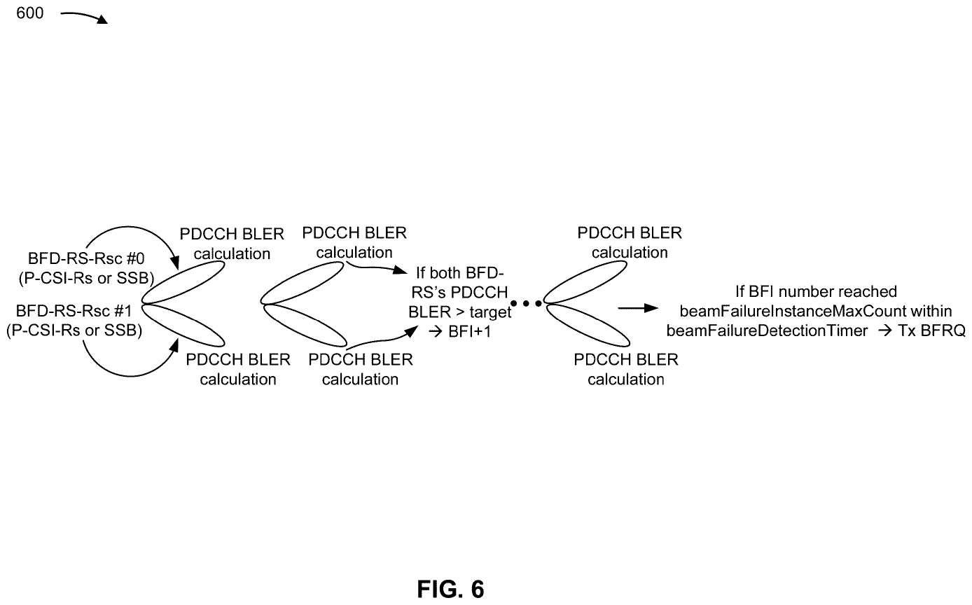

FIG. 6 is a diagram illustrating an example 600 of BFD. As shown in FIG. 6, a UE may monitor a first BFD-RS resource (BFD-RS-Rsc #0), which may be associated with a periodic CSI-RS or SSB. The UE may perform a first PDCCH BLER calculation based at least in part on the first BFD-RS resource. The UE may monitor a second BFD-RS resource (BFD-RS-Rsc #1), which may be associated with a periodic CSI-RS or SSB. The UE may perform a second PDCCH BLER calculation based at least in part on the second BFD-RS resource. When both the first PDCCH BLER calculation and the second PDCCH BLER calculation are greater than a threshold, the UE may determine a BFI. The UE may repeat this process a plurality of times. When a total number of BFIs is reached within a certain duration, the UE may transmit a BFRQ transmission.

In some examples of BFD, the UE may only detect beam failure after beam failure has already occurred. The UE may rely on measured L1-RSRP measurements of BFD-RSs to identify hypothesis PDCCH BLERs. Such an approach may potentially lead to a longer latency for the UE to identify an alternative new beam, and thus a degraded throughput performance.

As indicated above, FIG. 6 is provided as an example. Other examples may differ from what is described with regard to FIG. 6.

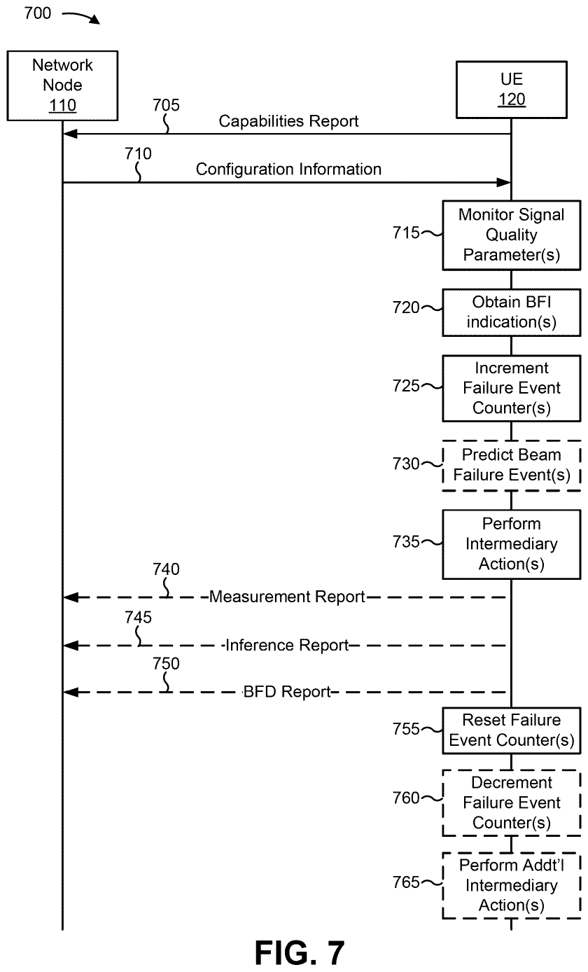

FIG. 7 is a diagram of an example 700 associated with intermediary beam failure detection conditions for pre-beam-failure actions or procedures. As shown in FIG. 7, a network node 110 (e.g., a base station, a CU, a DU, or an RU) may communicate with a UE 120. In some aspects, the network node 110 and the UE 120 may be part of a wireless network (e.g., the wireless communication network 100). The UE 120 and the network node 110 may have established a wireless connection prior to operations shown in FIG. 7.

In various aspects of techniques and apparatuses described herein, the UE 120 may perform a BFD procedure including one or more intermediary BFD states (e.g., one or more warning states in which a count of the BFI counter is greater than zero and less than the BFI threshold for declaring beam failure). Additional aspects may relate to artificial intelligence or machine learning (AI/ML)-based BFD event prediction.

In some aspects, as shown by reference number 705, the UE 120 may transmit capability information. The capability information may be included in a capability report. The UE 120 may transmit the capability information via an uplink communication, a sidelink communication, a unicast communication, a broadcast communication, a UE assistance information (UAI) communication, an uplink control information (UCI) communication, a sidelink control information (SCI) communication, a MAC-CE communication, an RRC communication, a PUCCH, a PUSCH, a physical sidelink control channel (PSCCH), or a physical sidelink shared channel (PSSCH), among other examples. The capability information may indicate one or more parameters associated with respective capabilities of the UE 120. The one or more parameters may be indicated via respective information elements (IEs) included in a capability report.

The capability information may indicate whether the UE 120 supports a feature or one or more parameters related to the feature. For example, the capability information may indicate a capability or parameter for identifying or acting in accordance with intermediary beam failure detection conditions for triggering pre-beam-failure actions. As another example, the capability information may indicate a capability or parameter for performing pre-beam-failure actions according to beam failure detection conditions associated with AI/ML-based beam failure prediction. One or more operations described herein may be based on the capability information. For example, the UE 120 may perform a communication in accordance with the capability information, or may receive configuration information that is in accordance with the capability information. In some aspects, the capability information may indicate UE support for a BFD procedure including one or more intermediary BFD states (e.g., one or more warning states in which a count of the BFI counter is greater than zero and less than the BFI threshold for declaring beam failure).

As shown by reference number 710, the network node 110 may transmit, and the UE 120 may receive, configuration information. In some aspects, the UE 120 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC-CEs or one or more DCI messages, among other examples.

In some aspects, the configuration information may include an indication of a selection of one or more configuration parameters (e.g., a selection of the one or more configuration parameters already known to the UE 120 or previously indicated by the network node or other network device), or explicit configuration information for the UE 120 to use to configure the UE 120, among other examples. In some aspects, the configuration information may include control signaling that indicates a set of one or more pre-beam-failure actions. In some aspects, the configuration information may include control signaling (e.g., RRC signaling) that indicates a corresponding value for each beam failure threshold of a set of one or more beam failure thresholds. In some aspects, each corresponding value may include at least one of an absolute value for satisfying a corresponding beam failure threshold, or a value that is relative to the beam failure detection threshold satisfying the corresponding beam failure threshold. In some aspects, the set of one or more beam failure thresholds includes a monitoring threshold (e.g., an upper bound of a BFI counter below which the UE 120 may operate in a monitoring state) and a beam failure detection threshold (e.g., a lower bound of a BFI counter above which the UE 120 may operate in a beam failure detected state or may trigger BFR).

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate that the UE 120 is to perform a BFD procedure including one or more intermediary BFD states (e.g., one or more warning states in which a count of the BFI counter is greater than zero and less than the BFI threshold for declaring beam failure), or is to perform AI/ML-based BFD event prediction in association with the BFD procedure including the one or more intermediary BFD states.

The UE 120 may configure itself based at least in part on the configuration information. In some aspects, the UE 120 may be configured to perform one or more operations described herein based at least in part on the configuration information.

As shown by reference number 715, the UE 120 may monitor one or more signal quality parameters. For example, the UE 120 may monitor one or more signal quality parameters associated with communications via a communication beam.

As shown by reference number 720, the UE 120 may obtain one or more BFI indications. For example, the UE 120 may obtain, in association with monitoring the one or more signal quality parameters described in connection with reference number 715, a BFI indication associated with the communication beam.

As shown by reference number 725, the UE 120 may increment one or more failure event counters. For example, the UE 120 may increment, in accordance with obtaining the BFI indication described in connection with reference number 720, a failure event counter from a first value to a second value. In some aspects, the second value may be less than or equal to a beam failure detection threshold and greater than or equal to a monitoring threshold. In some aspects, the monitoring threshold is different from the beam failure detection threshold. In some aspects, the failure event counter may include a global beam failure event counter (e.g., BFI_COUNTER) that is associated with a cumulative quantity of obtained BFI indications within a duration of time (e.g., as defined by a timer). In some aspects, the UE 120 may increment, in accordance with obtaining the BFI indication described in connection with reference number 720, an additional failure event counter. In such aspects, the failure event counter may be associated with a first set of beam failure parameters and the additional failure event counter may be associated with a second set of beam failure parameters that is different than the first set of beam failure parameters. For example, the second BFI counter may include a local BFI counter and may have or be associated with parameter values for a corresponding BFI maximum count value, and/or a corresponding beam failure detection timer duration different than parameter values for a corresponding BFI maximum count value, and/or a corresponding beam failure detection timer duration associated with the first BFI counter, which may include a global BFI counter.

In some aspects, the first value may be associated with a monitoring state, and the second value may be associated with a beam failure warning state. In some other aspects, the first value may be associated with a first beam failure warning state, and the second value may be associated with a second beam failure warning state. In some other aspects, the first value and the second value may each be associated with a beam failure warning state (e.g., a same beam failure warning state). In some other aspects, the first value may be associated with a monitoring state, and the second value may be associated with a beam failure detection state.

As shown by reference number 730, the UE 120 may predict one or more beam failure events. For example, the UE 120 may generate, in accordance with monitoring the one or more signal quality parameters described in connection with reference number 715, a predicted beam failure event associated with the communication beam. In some aspects, performing the action described in connection with reference number 735 may be associated with one or more characteristics of the predicted beam failure event satisfying a threshold. In some aspects, the one or more characteristics of the predicted beam failure event may include one or more of a timing of the predicted beam failure event associated with the communication beam (e.g., when a predicted beam failure event will occur), a probability that the predicted beam failure event associated with the communication beam is likely to occur, or a confidence level associated with the predicted beam failure event, or any combination thereof. For example, the UE 120 may predict, or generate based on one or more predictions, a time window in which the predicted BFD is likely to occur, a predicted BFD probability threshold, whether the predicted BFD event has a higher probability of occurrence than the threshold, a confidence level threshold associated with the predicted BFD event or parameters associated with the predicted BFD event, or whether the predicted BFD event is associated with a higher confidence level than the confidence level threshold.

As shown by reference number 735, the UE 120 may perform one or more intermediary actions. For example, the UE 120 may perform an action in accordance with the second value satisfying a beam failure threshold of a set of one or more beam failure thresholds. In some aspects, each beam failure threshold of the set of one or more beam failure thresholds may be associated with at least one action of the set of one or more pre-beam-failure actions described in connection with reference number 710. In some aspects, the beam failure threshold may be associated with a non-zero probability that a beam failure event will occur during a subsequent quantity of time resources. For example, a warning state associated with the beam failure threshold may include a situation in which BFD is not yet declared, but the likelihood of BFD occurring in a relatively near future is high. In some aspects, each beam failure threshold of the set of one or more beam failure thresholds may be associated with at least one corresponding value that is less than the beam failure detection threshold and greater than or equal to the monitoring threshold. For example, one or more intermediary warning states may be defined for the BFD operation shown in example 700.

In some aspects, performing the action may include performing a beam switching procedure associated with the beam failure threshold. For example, based on entering an intermediary state associated with the beam failure threshold, the UE 120 may perform a beam switching procedure and may communicate using a different communication beam, or may perform a beam selection procedure, for example, such as the beam selection procedure described in connection with FIG. 3, to select a new communication beam for communications.

In some aspects, performing the action may include performing a cell switching procedure associated with the beam failure threshold. In such aspects, the cell switching procedure may include at least one of a conditional handover procedure or a conditional lower layer triggered mobility cell switching procedure. For example, performing either switching procedure may be conditional on one or more conditions, such as the beam failure threshold, among other examples, being satisfied and may result in the UE 120 communicating via a new cell.

In some aspects, performing the action may include activating a beam failure prediction procedure using one or more of an AI/ML model or a historical data model. For example, in accordance with entering a warning state, the UE 120 may initiate BFD prediction. In such examples, the UE 120 may refrain from predicting the beam failure events described in connection with reference number 730 prior to entering a warning state associated with beam failure prediction.

In some aspects, performing the action in accordance with the second value satisfying the beam failure threshold may be associated with the second value satisfying the beam failure threshold while a beam failure detection timer is active. For example, conditions for the UE 120 to transition between operating states (e.g., transitioning to a warning state) may include or be based on a BFD timer.

As shown by reference number 740, the UE 120 may transmit, and the network node 110 may receive, a measurement report. For example, the UE 120 may transmit, and the network node 110 may receive, a measurement report in association with monitoring the one or more signal quality parameters described in connection with reference number 715. In some aspects, the measurement report may include a channel status report that includes a CQI, a rank indicator, a PMI, an L1 RSRP, or an L1 SINR, or any combination thereof, associated with communications performed via a wireless communications channel between the UE 120 and the network node 110. In some aspects, the measurement report may include a beam measurement report or a cell measurement report, and may indicate one or more of an L3 RSRP, an L3 SINR, or an RSRQ, or any combination thereof, associated with communications performed via the communication beam or a cell associated with the UE 120.

In some aspects, communicating the measurement report may include communicating at least one of UCI or a MAC-CE including the measurement report. In some aspects, the measurement report may be associated with the communication beam, a serving cell associated with the UE, or a candidate cell (e.g., a potential target cell for a handover procedure, a potential secondary cell for carrier aggregation applications, or a neighboring cell considered for potential handover or cell reselection, among other examples) associated with the UE 120, or any combination thereof.

As shown by reference number 745, the UE 120 may transmit, and the network node 110 may receive, an inference report. For example, the UE 120 may transmit, and the network node 110 may receive, a report including one or more inferences regarding a future or predicted beam failure event or including one or more inferences regarding future or predicted characteristics of the communication beam or a cell associated with the UE 120.

In some aspects, the inference report may include an L1 inference report that indicates predicted CSI, or one or more beam parameter predictions (e.g., associated with the communication beam). In some aspects, the inference report may include an L3 beam inference report, or an L3 cell inference report that indicates a predicted RSRP, a predicted SINR, or a predicted RSRQ, or any combination thereof, associated with communications to be performed via the communication beam or a cell associated with the UE 120.

As shown by reference number 750, the UE 120 may transmit, and the network node 110 may receive, a BFD report. In some aspects, communicating the BFD report may include communicating a MAC-CE including the beam failure detection report. In some aspects, the BFD report may indicate a value of the failure event counter (e.g., a current value), a value of an additional failure event counter (e.g., a value of a global event counter, a local event counter, or both), a confidence level (e.g., a reliability, certainty, or expectation of being within an accuracy range) associated with the predicted beam failure event described in connection with reference number 730 (e.g., a confidence level for one or more parameters of the predicted beam failure event, such as timing), a probability that the predicted beam failure event associated with the communication beam is likely to occur, a timing of the predicted beam failure event associated with the communication beam, a measurement report for a serving cell associated with the UE 120, a measurement report for a neighboring cell associated with the UE 120, a measurement report for a candidate cell associated with the UE 120, or any combination thereof.

As shown by reference number 755, the UE 120 may reset one or more failure event counters. For example, the one or more failure event counters may include at least a local beam failure event counter that is associated with a quantity of BFI indications obtained between satisfying a first threshold and satisfying a second threshold. The local BFI counter is a BFI counter in addition to a global BFI counter, that may be initiated or reset when the UE enters a warning state associated with satisfying a beam failure detection threshold. In such aspects, the UE 120 may reset the local BFI counter to zero in association with the beam failure threshold, for example as described in connection with reference number 735, including the second threshold.

As shown by reference number 760, the UE 120 may decrement the one or more failure event counters. For example, the UE 120 may decrement the failure event counter from the second value to a third value in association with at least one of a beam failure detection timer expiring, or one or more parameters associated with a predicted beam failure event satisfying a condition. In such aspects, as shown by reference number 765, the UE 120 may perform an additional intermediary action. For example, the UE 120 may perform an additional action in accordance with the third value satisfying an additional beam failure threshold of the set of one or more beam failure thresholds.

In some aspects, the beam failure detection timer expiring and the one or more parameters associated with the predicted beam failure event satisfying the condition may be associated with a probability of beam failure that is less than a probability of beam failure associated with the beam failure threshold. For example, the UE 120 may decrement the counter when both the BFD timer has expired and any AI/ML prediction results indicate a low probability of BFD occurring in a relatively near future time period.

In some aspects, the third value may satisfy at least one of an additional beam failure threshold of the set of one or more beam failure thresholds, or the monitoring threshold. For example, the third value may be associated with a warning state or the monitoring state, that is different from an operating state associated with the beam failure threshold. In some aspects, the third value may be greater than or equal to zero and may be less than the monitoring threshold. For example, decrementing the failure event counter to the third value may cause the UE 120 to perform one or more procedures or actions associated with the monitoring state (e.g., may cause the UE 120 to enter the monitoring state).

In some aspects, such enhancements may shorten a latency of BFD and related new beam identification procedures, or may conserve resources associated with performing a preventable or avoidable BFR procedure, especially when intermediary actions are taken as described herein or factors for BFI counting and BFI timer adjustment are configured appropriately.

As indicated above, FIG. 7 is provided as an example. Other examples may differ from what is described with respect to FIG. 7.

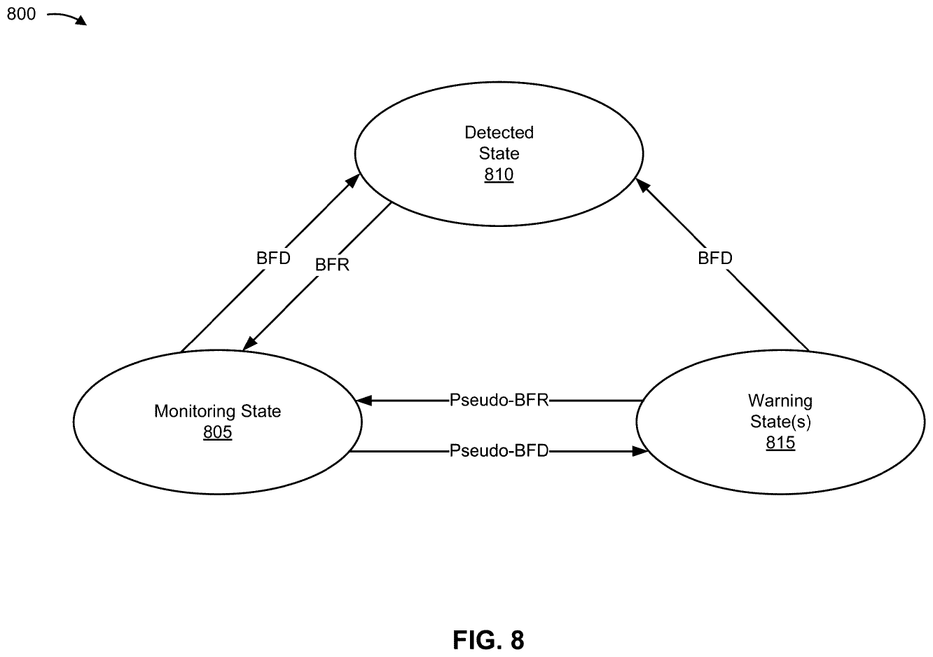

FIG. 8 is a diagram illustrating an example 800 of a BFD procedure including at least one warning state. As shown in FIG. 8, the BFD procedure of example 800 may include a plurality of operating states including: a monitoring state 805, in which a UE may monitor communication parameters to detect beam failure; a detected state 810, in which beam failure has been detected; and at least one warning state 815, in which the UE may perform one or more intermediary actions (e.g., actions that are intermediate to, performed prior to, performed to prevent, or performed to prepare for entering the detected state 810), for example as part of a pseudo-BFR or pseudo-BFD procedure. As used herein, pseudo-BFR and pseudo BFD refer, respectively to BFR and BFD procedures that cause the UE to transition between the monitoring state 805 and the warning state 815, and may include one or more different features than or may omit one or more features of BFR/BFD procedures that cause the UE to transition to or from the detected state 810.

According to some BFD procedures (e.g., BFD procedures in which there is no intermediary or warning state 815, BFD procedures that cause the UE to transition to or from the detected state 810), a UE may be in, or perform operations according to, one of two operating states: the monitoring state 805, or the detected state 810. According to such BFD procedures, in the monitoring state 805, a BFI counter may have a value that is greater than or equal to zero and is less than a maximum BFI count value, and in the detected state 810, the BFI counter may have met or exceeded the maximum BFI count value and, as a result, BFR may be triggered and the UE may initiate or perform a random access procedure, which may cause a relatively long service interruption.

However, combining of BFD operations with LTM-related procedures and techniques, or AI/ML-related procedures and techniques, may improve user experience by supporting the quick triggering of LTM cell switching in association with BFD prediction (e.g., before BFD is declared).

BFD procedures including at least one intermediary or warning state 815 may include pseudo-BFD operations in association with a BFI counter having a value that is relatively close to a maximum BFI threshold, or that is associated with a likelihood that BFD will be declared. For example, the warning state 815 may be associated with proactive or expedited measures for beam failure. The warning state 815 may include a pseudo-BFD situation in which BFD is not yet detected, but the chance of BFD being declared in a relatively near future is high.

One or more conditions for transitioning from the monitoring state 805 to the warning state 815 may include any combination of: an autonomous evaluation performed by the UE that is based on historical measurements or AI/ML-based predictions; or network-node-specific configurations (e.g., counter values or thresholds, quantity of warning states 815) associated with pseudo-BFD or the warning state(s) 815, among other examples. When communications between the UE and the network node satisfy one or more pseudo-BFD conditions or when the UE enters a warning state 815, the UE may trigger or perform various preventive measures (e.g., measurement report transmission, conditional cell switch, or event prediction, among other examples) (e.g., for example as part of a pseudo-BFR procedure). As a result, the UE may operate between the detected state 815, the monitoring state 805, and the one or more warning states 815 according to the example 800.

As indicated above, FIG. 8 is provided as an example. Other examples may differ from what is described with respect to FIG. 8.

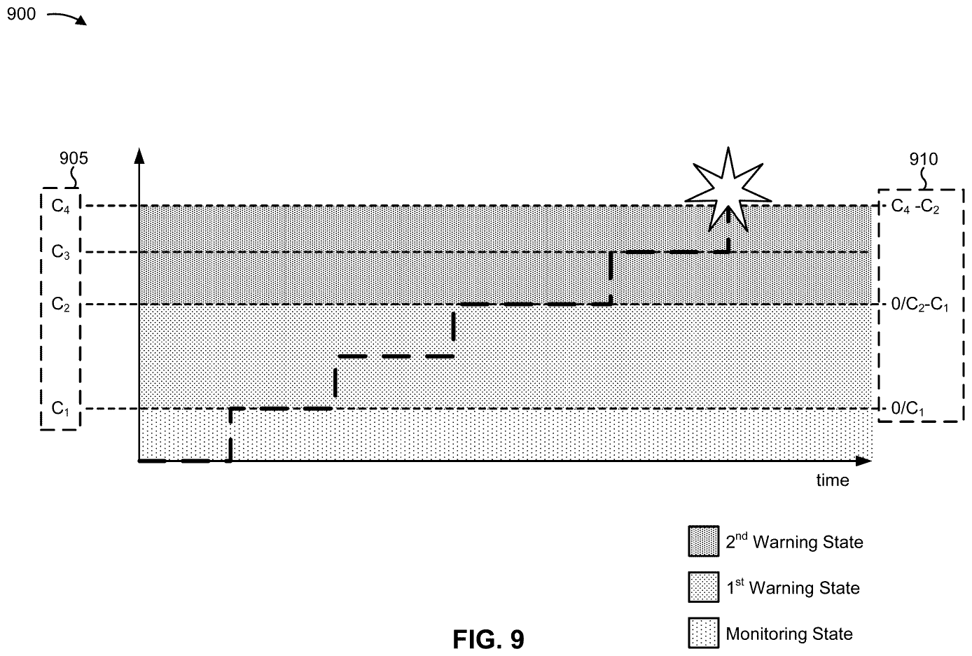

FIG. 9 is a diagram illustrating an example 900 of a failure event counter that is incremented through multiple intermediary states.

The example 900 may include a global counter 905, a local counter 910, or both. The local counter 910 is a counter that is separate from the global counter 905, and may start being incremented from zero (e.g., may be reset to zero) each time the UE enters a warning state. A UE may communicate with a network node via a communication beam and may obtain one or more BFIs in association with monitoring one or more communication parameters. The UE may increment the global counter 905 each time the UE obtains a BFI. For example, the UE may operate as part of the monitoring state until the global counter 905 is incremented to a value of C₁, at which point the UE may enter the first warning state, or may perform one or more actions associated with the first warning state. The local counter 910 may have a value of zero when the global counter 905 has a value of C₁. The UE may continue to obtain BFIs and increment the global counter 905 to a value of C₂ and the local counter to a value of C₂−C₁, at which point the UE may enter the second warning state, or may perform one or more actions associated with the second warning state. In some aspects, the UE may reset a count of the local counter 910 to zero in accordance with entering the second warning state.

The UE may continue to obtain BFIs and increment the global counter 905 to a value of C₃ and then C₄, and may increment the local counter to a value of C₄−C₂, at which point the UE may enter the detected state, or may perform one or more actions associated with BFR. Each warning state may be associated with a set of corresponding actions, for example, which in some aspects may be configured by the network node.

In some aspects, the conditions for transitioning to a warning state may include a value of the global counter 905 being reached, or a value of the local counter 910 being reached. The local counter 910 may have or be associated with different values of a BFI maximum count, or a corresponding beam failure detection timer, or both. In some aspects, the conditions for transitioning to a warning state may include a count of the global counter 905 or the local counter 910 being reached during an active duration of a BFD timer (e.g., prior to expiry of the timer or a corresponding timer).

In some aspects, the transition from the monitoring state to the first warning state may be based on a value of the BFI counter (e.g., the global counter 905 reaches C₁, or the local counter 910 reaches C₁, or both) rather than based on a value of the BFI counter and one or more BFD predictions. In some aspects, the transition from the first warning state to the second warning state may be based on a value of either or both counters and one or more BFD predictions (e.g., the global counter reaches C₂ or the local counter reaches C₂−C₁, and the BFD prediction results indicate that beam failure is likely).

For example, the UE may perform AI/ML-based BFD event prediction, including, in some aspects, event timing prediction. In some aspects, the UE may predict that the BFD timing is within a time window (e.g., the UE may predict an imminent BFD event). In some aspects, the predicted BFD event may be compared to a predicted BFD probability threshold. For example, the UE may determine whether the predicted BFD event has a higher probability of occurrence than the predicted BFD probability threshold. In some aspects, the UE may generate or determine a predicted BFD confidence level threshold. For example, the UE may determine whether the predicted BFD event is associated with a higher confidence level than the predicted BFD confidence level threshold. In some aspects, the BFD event prediction satisfying the time window or satisfying either threshold may transition the UE from the first warning state to the second warning state.

In some aspects, the warning state related parameters (e.g., threshold values, quantity of warning states, timer values) may be provided to the UE via RRC signaling.

In some aspects, the UE may assume a delta signaling using the parameters configured for the BFD without warning states as a baseline. Thus, if parameters are absent in the configuration for BFD including one or more warning states, then the UE may use the value indicated by the configuration for BFD without warning states. In some aspects, a BFD timer may be omitted from the parameters for warning states, and as a result, the UE may use the BFD timer configured for the BFD without warning states.

Each parameter value can be indicated as an absolute value (e.g., using the same units as parameters for BFD without warning states) or may be indicated as a relative value (e.g., a proportion of t parameters for BFD without warning states). For example, when a maximum BFI counter value for BFD without warning states is 8, a BFI threshold for BFD including one or more warning states may include: an explicit value, such as 4; or a proportion, such as 50% or ½ of the maximum BFI counter value for BFD without warning states.

While the example 900 depicts two warning states, BFD including a single warning state or more than two warning states may be performed. As indicated above, FIG. 9 is provided as an example. Other examples may differ from what is described with respect to FIG. 9.

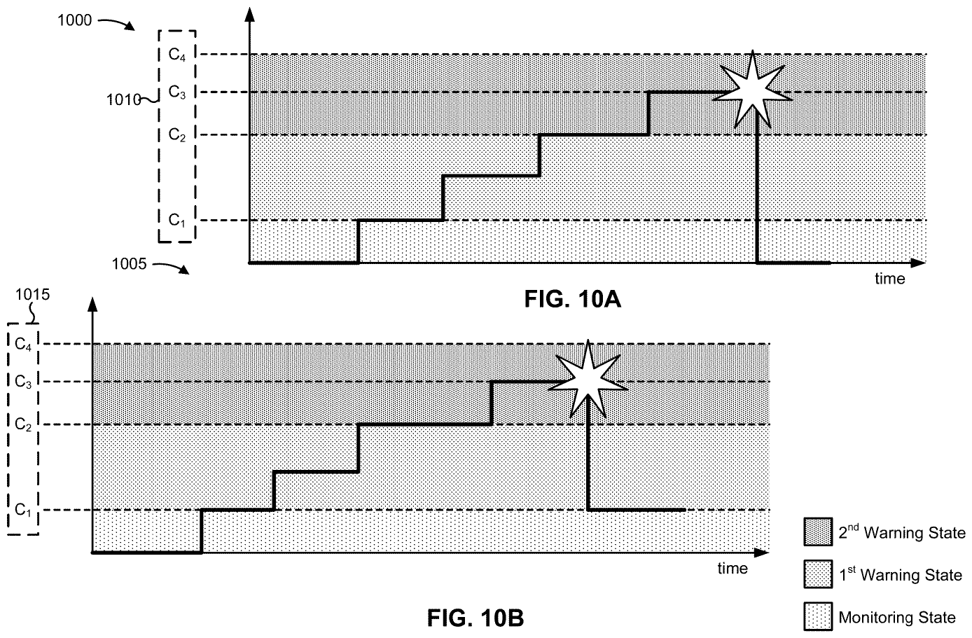

FIG. 10A is a diagram illustrating an example 1000 of a global event counter that is decremented to a monitoring state. As shown in example 1000, a UE may transition operating states, for example from a second warning state to the monitoring state (e.g., an operating state associated with a lowest likelihood that BFD will occur). For example, the UE may transition to an operating state associated with a lowest likelihood of beam failure when one or more conditions are satisfied. In some examples, the one or more conditions may include a BFD timer expiring, one or more AI/ML predictions, such as BFD timing outside of a time window, a BFD event probability that does not satisfy a probability threshold, a BFD event confidence level that does not satisfy a confidence level threshold, or any combination thereof. In some examples, the operating state transition may be performed when both the BFD timer has expired and any AI/ML prediction results indicate a low likelihood of a BFD event in the future (e.g., a near future, a future time window, among other examples). In such aspects, a global counter 1010, or a local counter (not shown) may be reset to zero.

FIG. 10B is a diagram illustrating an example 1005 of a global event counter that is decremented to a warning state. As shown in example 1005, a UE may transition operating states, for example from a second warning state to the first warning state (e.g., an operating state associated with a next lowest likelihood that BFD will occur). For example, the UE may transition to an operating state associated with a lower or next lower likelihood of beam failure when one or more conditions are satisfied. In some examples, the one or more conditions may include a BFD timer expiring, one or more AI/ML predictions, such as BFD timing outside of a time window, a BFD event probability that does not satisfy a probability threshold, a BFD event confidence level that does not satisfy a confidence level threshold, or any combination thereof. In some examples, the operating state transition may be performed when both the BFD timer has expired and any AI/ML prediction results indicate a low likelihood of a BFD event in the future (e.g., a near future, a future time window, among other examples). In such aspects, a global counter 1015 may be set to a lowest value associated with the lower warning state and a local counter (not shown) may be reset to zero. For example, in the example 1005, the global counter 1015 may be set to C₁ which is the threshold value for entering the first warning state.

As indicated above, FIGS. 10A and 10B are provided as examples. Other examples may differ from what is described with respect to FIGS. 10A and 10B.

FIG. 11 is a diagram illustrating an example process 1100 performed, for example, at a UE or an apparatus of a UE. Example process 1100 is an example where the apparatus or the UE (e.g., UE 120) performs operations associated with intermediary beam failure detection conditions for pre-beam-failure actions.

As shown in FIG. 11, in some aspects, process 1100 may include monitoring one or more signal quality parameters associated with communications via a communication beam (block 1110). For example, the UE (e.g., using communication manager 1306, depicted in FIG. 13) may monitor one or more signal quality parameters associated with communications via a communication beam, as described above.

As further shown in FIG. 11, in some aspects, process 1100 may include obtaining, in association with monitoring the one or more signal quality parameters, a BFI indication associated with the communication beam (block 1120). For example, the UE (e.g., using reception component 1302 or communication manager 1306, depicted in FIG. 13) may obtain, in association with monitoring the one or more signal quality parameters, a BFI indication associated with the communication beam, as described above.

As further shown in FIG. 11, in some aspects, process 1100 may include incrementing, in accordance with obtaining the BFI indication, a failure event counter from a first value to a second value, wherein the second value is less than or equal to a beam failure detection threshold and greater than or equal to a monitoring threshold (block 1130). For example, the UE (e.g., using communication manager 1306, depicted in FIG. 13) may increment, in accordance with obtaining the BFI indication, a failure event counter from a first value to a second value, wherein the second value is less than or equal to a beam failure detection threshold and greater than or equal to a monitoring threshold, as described above.

As further shown in FIG. 11, in some aspects, process 1100 may include performing an action in accordance with the second value satisfying a beam failure threshold of a set of one or more beam failure thresholds (block 1140). For example, the UE (e.g., using communication manager 1306, depicted in FIG. 13) may perform an action in accordance with the second value satisfying a beam failure threshold of a set of one or more beam failure thresholds, as described above.

Process 1100 may include additional aspects, such as any single aspect or any combination of aspects described below or in connection with one or more other processes described elsewhere herein.

In a first aspect, each beam failure threshold of the set of one or more beam failure thresholds is associated with at least one action of a set of one or more pre-beam-failure actions.

In a second aspect, alone or in combination with the first aspect, process 1100 includes receiving control signaling indicating the set of one or more pre-beam-failure actions.

In a third aspect, alone or in combination with one or more of the first and second aspects, performing the action comprises transmitting, to a network node, a measurement report in association with monitoring the one or more signal quality parameters.

In a fourth aspect, alone or in combination with one or more of the first through third aspects, transmitting the measurement report comprises transmitting at least one of uplink control information or a MAC-CE including the measurement report.

In a fifth aspect, alone or in combination with one or more of the first through fourth aspects, the measurement report is associated with at least one of the communication beam, a serving cell associated with the UE, or a candidate cell associated with the UE.

In a sixth aspect, alone or in combination with one or more of the first through fifth aspects, the measurement report comprises a channel status report that includes one or more of a channel quality index, a rank indicator, a precoding matrix indicator, an L1 reference signal received power, or an L1 signal-to-interference-plus-noise ratio.

In a seventh aspect, alone or in combination with one or more of the first through sixth aspects, the measurement report comprises at least one of a beam measurement report or a cell measurement report, and the measurement report includes one or more of an L3 reference signal received power, an L3 signal-to-interference-plus-noise ratio, or a reference signal received quality.

In an eighth aspect, alone or in combination with one or more of the first through seventh aspects, performing the action comprises transmitting, to a network node, an inference report.

In a ninth aspect, alone or in combination with one or more of the first through eighth aspects, the inference report comprises an L1 inference report including one or more of predicted CSI, or one or more beam parameter predictions.

In a tenth aspect, alone or in combination with one or more of the first through ninth aspects, the inference report comprises at least one of an L3 beam inference report, or an L3 cell inference report that includes one or more of a predicted RSRP, a predicted SINR, or a predicted RSRQ.

In an eleventh aspect, alone or in combination with one or more of the first through tenth aspects, performing the action comprises transmitting, to a network node, a beam failure detection report.

In a twelfth aspect, alone or in combination with one or more of the first through eleventh aspects, transmitting the beam failure detection report comprises transmitting a MAC-CE including the beam failure detection report.

In a thirteenth aspect, alone or in combination with one or more of the first through twelfth aspects, the beam failure detection report includes one or more of a value of the failure event counter, a value of an additional failure event counter, a confidence level associated with a predicted beam failure event, a probability that a predicted beam failure event associated with the communication beam is likely to occur, a timing of a predicted beam failure event associated with the communication beam, a measurement report for a serving cell associated with the UE, a measurement report for a neighboring cell associated with the UE, or a measurement report for a candidate cell associated with the UE.

In a fourteenth aspect, alone or in combination with one or more of the first through thirteenth aspects, performing the action comprises performing a beam switching procedure associated with the beam failure threshold.

In a fifteenth aspect, alone or in combination with one or more of the first through fourteenth aspects, performing the action comprises performing a cell switching procedure associated with the beam failure threshold.

In a sixteenth aspect, alone or in combination with one or more of the first through fifteenth aspects, the cell switching procedure includes at least one of a conditional handover procedure or a conditional lower layer triggered mobility cell switching procedure.

In a seventeenth aspect, alone or in combination with one or more of the first through sixteenth aspects, performing the action comprises activating a beam failure prediction procedure using one or more of an AI/ML model or a historical data model.

In an eighteenth aspect, alone or in combination with one or more of the first through seventeenth aspects, the beam failure threshold is associated with a non-zero probability that a beam failure event will occur during a subsequent quantity of time resources.

In a nineteenth aspect, alone or in combination with one or more of the first through eighteenth aspects, each beam failure threshold of the set of one or more beam failure thresholds is associated with at least one corresponding value that is less than the beam failure detection threshold and greater than or equal to the monitoring threshold.

In a twentieth aspect, alone or in combination with one or more of the first through nineteenth aspects, the failure event counter includes a global beam failure event counter that is associated with a cumulative quantity of obtained BFI indications within a duration of time.

In a twenty-first aspect, alone or in combination with one or more of the first through twentieth aspects, the failure event counter includes a local beam failure event counter that is associated with a quantity of BFI indications obtained between satisfying a first threshold and satisfying a second threshold.

In a twenty-second aspect, alone or in combination with one or more of the first through twenty-first aspects, process 1100 includes resetting the local beam failure event counter to zero in association with the beam failure threshold including the second threshold.

In a twenty-third aspect, alone or in combination with one or more of the first through twenty-second aspects, process 1100 includes incrementing, in accordance with obtaining the BFI indication, an additional failure event counter, wherein the failure event counter is associated with a first set of beam failure parameters and the additional failure event counter is associated with a second set of beam failure parameters that is different than the first set of beam failure parameters.

In a twenty-fourth aspect, alone or in combination with one or more of the first through twenty-third aspects, at least one of the first set of beam failure parameters or the second set of beam failure parameters includes one or more of a corresponding BFI maximum count, or a corresponding beam failure detection timer.

In a twenty-fifth aspect, alone or in combination with one or more of the first through twenty-fourth aspects, performing the action in accordance with the second value satisfying the beam failure threshold is associated with the second value satisfying the beam failure threshold while a beam failure detection timer is active.

In a twenty-sixth aspect, alone or in combination with one or more of the first through twenty-fifth aspects, process 1100 includes generating, in accordance with monitoring the one or more signal quality parameters, a predicted beam failure event associated with the communication beam, wherein performing the action is associated with one or more characteristics of the predicted beam failure event satisfying a threshold.

In a twenty-seventh aspect, alone or in combination with one or more of the first through twenty-sixth aspects, the one or more characteristics of the predicted beam failure event include one or more of a timing of the predicted beam failure event associated with the communication beam, a probability that the predicted beam failure event associated with the communication beam is likely to occur, or a confidence level associated with the predicted beam failure event.

In a twenty-eighth aspect, alone or in combination with one or more of the first through twenty-seventh aspects, the first value is associated with a monitoring state, and the second value is associated with a beam failure warning state.

In a twenty-ninth aspect, alone or in combination with one or more of the first through twenty-eighth aspects, the first value is associated with a first beam failure warning state, and the second value is associated with a second beam failure warning state.

In a thirtieth aspect, alone or in combination with one or more of the first through twenty-ninth aspects, the first value and the second value are each associated with a beam failure warning state.

In a thirty-first aspect, alone or in combination with one or more of the first through thirtieth aspects, the first value is associated with a monitoring state, and the second value is associated with a beam failure detection state.

In a thirty-second aspect, alone or in combination with one or more of the first through thirty-first aspects, process 1100 includes decrementing the failure event counter from the second value to a third value in association with at least one of a beam failure detection timer expiring, or one or more parameters associated with a predicted beam failure event satisfying a condition.

In a thirty-third aspect, alone or in combination with one or more of the first through thirty-second aspects, the third value satisfies at least one of an additional beam failure threshold of the set of one or more beam failure thresholds, or the monitoring threshold.

In a thirty-fourth aspect, alone or in combination with one or more of the first through thirty-third aspects, the third value is greater than or equal to zero and is less than the monitoring threshold.

In a thirty-fifth aspect, alone or in combination with one or more of the first through thirty-fourth aspects, the beam failure detection timer expiring and the one or more parameters associated with the predicted beam failure event satisfying the condition are associated with a probability of beam failure that is less than a probability of beam failure associated with the beam failure threshold.

In a thirty-sixth aspect, alone or in combination with one or more of the first through thirty-fifth aspects, process 1100 includes performing an additional action in accordance with the third value satisfying an additional beam failure threshold of the set of one or more beam failure thresholds.

In a thirty-seventh aspect, alone or in combination with one or more of the first through thirty-sixth aspects, process 1100 includes receiving control signaling that indicates a corresponding value for each beam failure threshold of the set of one or more beam failure thresholds.

In a thirty-eighth aspect, alone or in combination with one or more of the first through thirty-seventh aspects, each corresponding value includes at least one of an absolute value for satisfying a corresponding beam failure threshold, or a value that is relative to the beam failure detection threshold satisfying the corresponding beam failure threshold.

In a thirty-ninth aspect, alone or in combination with one or more of the first through thirty-eighth aspects, the control signaling comprises radio resource control signaling.

In a fortieth aspect, alone or in combination with one or more of the first through thirty-ninth aspects, the set of one or more beam failure thresholds includes the monitoring threshold and the beam failure detection threshold.

In a forty-first aspect, alone or in combination with one or more of the first through fortieth aspects, the monitoring threshold is different from the beam failure detection threshold.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node. Example process 1200 is an example where the apparatus or the network node (e.g., network node 110) performs operations associated with intermediary beam failure detection conditions for pre-beam-failure actions.

As shown in FIG. 12, in some aspects, process 1200 may include transmitting, to a UE, control signaling indicating a set of one or more pre-beam-failure actions (block 1210). For example, the network node (e.g., using transmission component 1404 or communication manager 1406, depicted in FIG. 14) may transmit, to a UE, control signaling indicating a set of one or more pre-beam-failure actions, as described above.

As further shown in FIG. 12, in some aspects, process 1200 may include monitoring one or more signal quality parameters associated with communications via a communication beam (block 1220). For example, the network node (e.g., using communication manager 1406, depicted in FIG. 14) may monitor one or more signal quality parameters associated with communications via a communication beam, as described above.

As further shown in FIG. 12, in some aspects, process 1200 may include performing an action of the set of one or more pre-beam-failure actions in association with a beam failure threshold, of a set of one or more beam failure thresholds, being satisfied, wherein a failure event counter associated with the communication beam being incremented from a first value that is less than or equal to a beam failure detection threshold to a second value that is greater than or equal to a monitoring threshold (block 1230). For example, the network node (e.g., using communication manager 1406, depicted in FIG. 14) may perform an action of the set of one or more pre-beam-failure actions in association with a beam failure threshold, of a set of one or more beam failure thresholds, being satisfied, wherein a failure event counter associated with the communication beam being incremented from a first value that is less than or equal to a beam failure detection threshold to a second value that is greater than or equal to a monitoring threshold, as described above.

Process 1200 may include additional aspects, such as any single aspect or any combination of aspects described below or in connection with one or more other processes described elsewhere herein.

In a first aspect, each beam failure threshold of the set of one or more beam failure thresholds is associated with at least one action of the set of one or more pre-beam-failure actions.

In a second aspect, alone or in combination with the first aspect, performing the action comprises receiving, from the UE, a measurement report in association with the one or more signal quality parameters.

In a third aspect, alone or in combination with one or more of the first and second aspects, receiving the measurement report comprises receiving at least one of uplink control information or a MAC-CE including the measurement report.

In a fourth aspect, alone or in combination with one or more of the first through third aspects, the measurement report is associated with at least one of the communication beam, a serving cell associated with the UE, or a candidate cell associated with the UE.

In a fifth aspect, alone or in combination with one or more of the first through fourth aspects, the measurement report comprises a channel status report that includes one or more of a CQI, a rank indicator, a precoding matrix indicator, an L1 RSRP, or an L1 SINR.

In a sixth aspect, alone or in combination with one or more of the first through fifth aspects, the measurement report comprises at least one of a beam measurement report or a cell measurement report, and the measurement report includes one or more of an L3 RSRP, an L3 SINR, or a RSRQ.

In a seventh aspect, alone or in combination with one or more of the first through sixth aspects, performing the action comprises receiving, from the UE, an inference report.

In an eighth aspect, alone or in combination with one or more of the first through seventh aspects, the inference report comprises an L1 inference report including one or more of predicted CSI, or one or more beam parameter predictions.

In a ninth aspect, alone or in combination with one or more of the first through eighth aspects, the inference report comprises at least one of an L3 beam inference report, or an L3 cell inference report that includes one or more of a predicted RSRP, a predicted SINR, or a predicted RSRQ.

In a tenth aspect, alone or in combination with one or more of the first through ninth aspects, performing the action comprises receiving, from the UE, a beam failure detection report.

In an eleventh aspect, alone or in combination with one or more of the first through tenth aspects, receiving the beam failure detection report comprises receiving a MAC-CE including the beam failure detection report.

In a twelfth aspect, alone or in combination with one or more of the first through eleventh aspects, the beam failure detection report includes one or more of a value of the failure event counter, a value of an additional failure event counter, a confidence level associated with a predicted beam failure event, a probability that a predicted beam failure event associated with the communication beam is likely to occur, a timing of a predicted beam failure event associated with the communication beam, a measurement report for a serving cell associated with the UE, a measurement report for a neighboring cell associated with the UE, or a measurement report for a candidate cell associated with the UE.

In a thirteenth aspect, alone or in combination with one or more of the first through twelfth aspects, performing the action comprises performing, with the UE, a beam switching procedure associated with the beam failure threshold.

In a fourteenth aspect, alone or in combination with one or more of the first through thirteenth aspects, performing the action comprises performing, with the UE, a cell switching procedure associated with the beam failure threshold.

In a fifteenth aspect, alone or in combination with one or more of the first through fourteenth aspects, the cell switching procedure includes at least one of a conditional handover procedure or a conditional lower layer triggered mobility cell switching procedure.

In a sixteenth aspect, alone or in combination with one or more of the first through fifteenth aspects, the beam failure threshold is associated with a non-zero probability that a beam failure event will occur during a subsequent quantity of time resources.

In a seventeenth aspect, alone or in combination with one or more of the first through sixteenth aspects, each beam failure threshold of the set of one or more beam failure thresholds is associated with at least one corresponding value that is less than the beam failure detection threshold and greater than or equal to the monitoring threshold.

In an eighteenth aspect, alone or in combination with one or more of the first through seventeenth aspects, the failure event counter includes a global beam failure event counter that is associated with a cumulative quantity of obtained BFI indications within a duration of time.

In a nineteenth aspect, alone or in combination with one or more of the first through eighteenth aspects, the failure event counter includes a UE-specific beam failure event counter that is associated with a quantity of BFI indications obtained between satisfying a first threshold and satisfying a second threshold.

In a twentieth aspect, alone or in combination with one or more of the first through nineteenth aspects, performing the action in accordance with the second value satisfying the beam failure threshold is associated with the second value satisfying the beam failure threshold while a beam failure detection timer is active.

In a twenty-first aspect, alone or in combination with one or more of the first through twentieth aspects, the first value is associated with a monitoring state of the UE, and the second value is associated with a beam failure warning state of the UE.

In a twenty-second aspect, alone or in combination with one or more of the first through twenty-first aspects, the first value is associated with a first beam failure warning state of the UE, and the second value is associated with a second beam failure warning state of the UE.

In a twenty-third aspect, alone or in combination with one or more of the first through twenty-second aspects, the first value and the second value are each associated with a beam failure warning state of the UE.

In a twenty-fourth aspect, alone or in combination with one or more of the first through twenty-third aspects, the first value is associated with a monitoring state of the UE, and the second value is associated with a beam failure detection state of the UE.

In a twenty-fifth aspect, alone or in combination with one or more of the first through twenty-fourth aspects, process 1200 includes transmitting control signaling that indicates a corresponding value for each beam failure threshold of the set of one or more beam failure thresholds.

In a twenty-sixth aspect, alone or in combination with one or more of the first through twenty-fifth aspects, each corresponding value includes at least one of an absolute value for satisfying a corresponding beam failure threshold, or a value that is relative to the beam failure detection threshold satisfying the corresponding beam failure threshold.

In a twenty-seventh aspect, alone or in combination with one or more of the first through twenty-sixth aspects, the control signaling comprises radio resource control signaling.

In a twenty-eighth aspect, alone or in combination with one or more of the first through twenty-seventh aspects, the set of one or more beam failure thresholds includes the monitoring threshold and the beam failure detection threshold.

In a twenty-ninth aspect, alone or in combination with one or more of the first through twenty-eighth aspects, the monitoring threshold is different from the beam failure detection threshold.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a UE, or a UE may include the apparatus 1300. In some aspects, the apparatus 1300 includes a reception component 1302, a transmission component 1304, or a communication manager 1306, which may be in communication with one another (for example, via one or more buses or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 140 described in connection with FIG. 1) of the UE.

In some aspects, the apparatus 1300 may be configured to perform one or more operations described herein in connection with FIGS. 7-10. Additionally, or alternatively, the apparatus 1300 may be configured to perform one or more processes described herein, such as process 1100 of FIG. 11, or a combination thereof. In some aspects, the apparatus 1300 or one or more components shown in FIG. 13 may include one or more components of the UE described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the UE described above in connection with FIG. 1, such as a radio, one or more RF chains, one or more transceivers, or one or more modems, each of which may in turn be coupled with one or more antennas of the UE.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1304 may be co-located with the reception component 1302.

The communication manager 1306 may support operations of the reception component 1302 or the transmission component 1304. For example, the communication manager 1306 may receive information associated with configuring reception of communications by the reception component 1302 or transmission of communications by the transmission component 1304. Additionally, or alternatively, the communication manager 1306 may generate or provide control information to the reception component 1302 or the transmission component 1304 to control reception or transmission of communications.

The communication manager 1306 may monitor one or more signal quality parameters associated with communications via a communication beam. The reception component 1302 may obtain, in association with monitoring the one or more signal quality parameters, a BFI indication associated with the communication beam. The communication manager 1306 may increment, in accordance with obtaining the BFI indication, a failure event counter from a first value to a second value, wherein the second value is less than or equal to a beam failure detection threshold and greater than or equal to a monitoring threshold. The communication manager 1306 may perform an action in accordance with the second value satisfying a beam failure threshold of a set of one or more beam failure thresholds.

The reception component 1302 may receive control signaling indicating the set of one or more pre-beam-failure actions.

The transmission component 1304 may transmit, to a network node, a measurement report in association with monitoring the one or more signal quality parameters.

The transmission component 1304 may transmit at least one of uplink control information or a MAC-CE including the measurement report. The transmission component 1304 may transmit, to a network node, an inference report. The transmission component 1304 may transmit, to a network node, a beam failure detection report. The transmission component 1304 may transmit a MAC-CE including the beam failure detection report.

The communication manager 1306 may perform a beam switching procedure associated with the beam failure threshold. The communication manager 1306 may perform a cell switching procedure associated with the beam failure threshold. The communication manager 1306 may activate a beam failure prediction procedure using one or more of an AI/ML model or a historical data model.

The communication manager 1306 may reset the local beam failure event counter to zero in association with the beam failure threshold including the second threshold.

The communication manager 1306 may increment, in accordance with obtaining the BFI indication, an additional failure event counter, wherein the failure event counter is associated with a first set of beam failure parameters and the additional failure event counter is associated with a second set of beam failure parameters that is different than the first set of beam failure parameters.

The communication manager 1306 may generate, in accordance with monitoring the one or more signal quality parameters, a predicted beam failure event associated with the communication beam, wherein performing the action is associated with one or more characteristics of the predicted beam failure event satisfying a threshold.

The communication manager 1306 may decrement the failure event counter from the second value to a third value in association with at least one of a beam failure detection timer expiring, or one or more parameters associated with a predicted beam failure event satisfying a condition.

The communication manager 1306 may perform an additional action in accordance with the third value satisfying an additional beam failure threshold of the set of one or more beam failure thresholds.

The reception component 1302 may receive control signaling that indicates a corresponding value for each beam failure threshold of the set of one or more beam failure thresholds.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a network node, or a network node may include the apparatus 1400. In some aspects, the apparatus 1400 includes a reception component 1402, a transmission component 1404, or a communication manager 1406, which may be in communication with one another (for example, via one or more buses or one or more other components). In some aspects, the communication manager 1406 is the communication manager 155 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 145 described in connection with FIG. 1) of the network node.

In some aspects, the apparatus 1400 may be configured to perform one or more operations described herein in connection with FIGS. 7-10. Additionally, or alternatively, the apparatus 1400 may be configured to perform one or more processes described herein, such as process 1200 of FIG. 12, or a combination thereof. In some aspects, the apparatus 1400 or one or more components shown in FIG. 14 may include one or more components of the network node described in connection with FIG. 1. Additionally, or alternatively, one or more components shown in FIG. 14 may be implemented within one or more components described in connection with FIG. 1.

Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the network node described above in connection with FIG. 1, such as a radio, one or more RF chains, one or more transceivers, or one or more modems, each of which may in turn be coupled with one or more antennas of the network node. In some aspects, the reception component 1402 or the transmission component 1404 may include or may be included in a network interface. The network interface may be configured to obtain or output signals for the apparatus 1400 via one or more communications links, such as a backhaul link, a midhaul link, or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1404 may be co-located with the reception component 1402.

The communication manager 1406 may support operations of the reception component 1402 or the transmission component 1404. For example, the communication manager 1406 may receive information associated with configuring reception of communications by the reception component 1402 or transmission of communications by the transmission component 1404. Additionally, or alternatively, the communication manager 1406 may generate or provide control information to the reception component 1402 or the transmission component 1404 to control reception or transmission of communications.

The transmission component 1404 may transmit, to a UE, control signaling indicating a set of one or more pre-beam-failure actions. The communication manager 1406 may monitor one or more signal quality parameters associated with communications via a communication beam. The communication manager 1406 may perform an action of the set of one or more pre-beam-failure actions in association with a beam failure threshold, of a set of one or more beam failure thresholds, being satisfied, wherein a failure event counter associated with the communication beam being incremented from a first value that is less than or equal to a beam failure detection threshold to a second value that is greater than or equal to a monitoring threshold.

The reception component 1402 may receive, from the UE, a measurement report in association with the one or more signal quality parameters. The reception component 1402 may receive at least one of uplink control information or a MAC-CE including the measurement report. The reception component 1402 may receive, from the UE, an inference report. The reception component 1402 may receive, from the UE, a beam failure detection report. The reception component 1402 may receive a MAC-CE including the beam failure detection report.

The communication manager 1406 may perform, with the UE, a beam switching procedure associated with the beam failure threshold. The communication manager 1406 may perform, with the UE, a cell switching procedure associated with the beam failure threshold.

The transmission component 1404 may transmit control signaling that indicates a corresponding value for each beam failure threshold of the set of one or more beam failure thresholds.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:
Aspect 1: A method of wireless communication performed by a user equipment (UE), comprising: monitoring one or more signal quality parameters associated with communications via a communication beam; obtaining, in association with monitoring the one or more signal quality parameters, a BFI indication associated with the communication beam; incrementing, in accordance with obtaining the beam failure instance indication, a failure event counter from a first value to a second value, wherein the second value is less than or equal to a beam failure detection threshold and greater than or equal to a monitoring threshold; and performing an action in accordance with the second value satisfying a beam failure threshold of a set of one or more beam failure thresholds.
Aspect 2: The method of Aspect 1, wherein each beam failure threshold of the set of one or more beam failure thresholds is associated with at least one action of a set of one or more pre-beam-failure actions.
Aspect 3: The method of Aspect 2, further comprising: receiving control signaling indicating the set of one or more pre-beam-failure actions.
Aspect 4: The method of any of Aspects 1-3, wherein performing the action comprises: transmitting, to a network node, a measurement report in association with monitoring the one or more signal quality parameters.
Aspect 5: The method of Aspect 4, wherein transmitting the measurement report comprises: transmitting at least one of uplink control information or a medium access control control element including the measurement report.
Aspect 6: The method of any of Aspects 4-5, wherein the measurement report is associated with at least one of the communication beam, a serving cell associated with the UE, or a candidate cell associated with the UE.
Aspect 7: The method of any of Aspects 4-6, wherein the measurement report comprises a channel status report that includes one or more of: a channel quality index, a rank indicator, a precoding matrix indicator, a layer 1 reference signal received power, or a layer 1 signal-to-interference plus noise ratio.
Aspect 8: The method of any of Aspects 4-7, wherein the measurement report comprises at least one of a beam measurement report or a cell measurement report, and the measurement report includes one or more of: a layer 3 reference signal received power, a layer 3 signal-to-interference plus noise ratio, or a reference signal received quality.
Aspect 9: The method of any of Aspects 1-8, wherein performing the action comprises: transmitting, to a network node, an inference report.
Aspect 10: The method of Aspect 9, wherein the inference report comprises a layer 1 inference report including one or more of: predicted channel state information, or one or more beam parameter predictions.
Aspect 11: The method of any of Aspects 9-10, wherein the inference report comprises at least one of a layer 3 beam inference report, or a layer 3 cell inference report that includes one or more of: a predicted reference signal received power, a predicted signal-to-interference plus noise ratio, or a predicted reference signal received quality.
Aspect 12: The method of any of Aspects 1-11, wherein performing the action comprises: transmitting, to a network node, a beam failure detection report.
Aspect 13: The method of Aspect 12, wherein transmitting the beam failure detection report comprises: transmitting a medium access control control element including the beam failure detection report.
Aspect 14: The method of any of Aspects 12-13, wherein the beam failure detection report includes one or more of: a value of the failure event counter, a value of an additional failure event counter, a confidence level associated with a predicted beam failure event, a probability that a predicted beam failure event associated with the communication beam is likely to occur, a timing of a predicted beam failure event associated with the communication beam, a measurement report for a serving cell associated with the UE, a measurement report for a neighboring cell associated with the UE, or a measurement report for a candidate cell associated with the UE.
Aspect 15: The method of any of Aspects 1-14, wherein performing the action comprises: performing a beam switching procedure associated with the beam failure threshold.
Aspect 16: The method of any of Aspects 1-15, wherein performing the action comprises: performing a cell switching procedure associated with the beam failure threshold.
Aspect 17: The method of Aspect 16, wherein the cell switching procedure includes at least one of a conditional handover procedure or a conditional lower layer triggered mobility cell switching procedure.
Aspect 18: The method of any of Aspects 1-17, wherein performing the action comprises: activating a beam failure prediction procedure using one or more of an artificial intelligence or machine learning (AI/ML) model or a historical data model.
Aspect 19: The method of any of Aspects 1-18, wherein the beam failure threshold is associated with a non-zero probability that a beam failure event will occur during a subsequent quantity of time resources.
Aspect 20: The method of any of Aspects 1-19, wherein each beam failure threshold of the set of one or more beam failure thresholds is associated with at least one corresponding value that is less than the beam failure detection threshold and greater than or equal to the monitoring threshold.
Aspect 21: The method of any of Aspects 1-20, wherein the failure event counter includes a global beam failure event counter that is associated with a cumulative quantity of obtained beam failure instance indications within a duration of time.
Aspect 22: The method of any of Aspects 1-21, wherein the failure event counter includes a local beam failure event counter that is associated with a quantity of beam failure instance indications obtained between satisfying a first threshold and satisfying a second threshold.
Aspect 23: The method of Aspect 22, further comprising: resetting the local beam failure event counter to zero in association with the beam failure threshold including the second threshold.
Aspect 24: The method of any of Aspects 1-23, further comprising: incrementing, in accordance with obtaining the beam failure instance indication, an additional failure event counter, wherein the failure event counter is associated with a first set of beam failure parameters and the additional failure event counter is associated with a second set of beam failure parameters that is different than the first set of beam failure parameters.
Aspect 25: The method of Aspect 24, wherein at least one of the first set of beam failure parameters or the second set of beam failure parameters includes one or more of: a corresponding beam failure instance maximum count, or a corresponding beam failure detection timer.
Aspect 26: The method of any of Aspects 1-25, wherein performing the action in accordance with the second value satisfying the beam failure threshold is associated with the second value satisfying the beam failure threshold while a beam failure detection timer is active.
Aspect 27: The method of any of Aspects 1-26, further comprising: generating, in accordance with monitoring the one or more signal quality parameters, a predicted beam failure event associated with the communication beam, wherein performing the action is associated with one or more characteristics of the predicted beam failure event satisfying a threshold.
Aspect 28: The method of Aspect 27, wherein the one or more characteristics of the predicted beam failure event include one or more of: a timing of the predicted beam failure event associated with the communication beam, a probability that the predicted beam failure event associated with the communication beam is likely to occur, or a confidence level associated with the predicted beam failure event.
Aspect 29: The method of any of Aspects 1-28, wherein the first value is associated with a monitoring state, and the second value is associated with a beam failure warning state.
Aspect 30: The method of any of Aspects 1-28, wherein the first value is associated with a first beam failure warning state, and the second value is associated with a second beam failure warning state.
Aspect 31: The method of any of Aspects 1-28, wherein the first value and the second value are each associated with a beam failure warning state.
Aspect 32: The method of any of Aspects 1-28, wherein the first value is associated with a monitoring state, and the second value is associated with a beam failure detection state.
Aspect 33: The method of any of Aspects 1-32, further comprising: decrementing the failure event counter from the second value to a third value in association with at least one of a beam failure detection timer expiring, or one or more parameters associated with a predicted beam failure event satisfying a condition.
Aspect 34: The method of Aspect 33, wherein the third value satisfies at least one of an additional beam failure threshold of the set of one or more beam failure thresholds, or the monitoring threshold.
Aspect 35: The method of Aspect 33, wherein the third value is greater than or equal to zero and is less than the monitoring threshold.
Aspect 36: The method of any of Aspects 33-35, wherein the beam failure detection timer expiring and the one or more parameters associated with the predicted beam failure event satisfying the condition are associated with a probability of beam failure that is less than a probability of beam failure associated with the beam failure threshold.
Aspect 37: The method of any of Aspects 33-36, further comprising: performing an additional action in accordance with the third value satisfying an additional beam failure threshold of the set of one or more beam failure thresholds.
Aspect 38: The method of any of Aspects 1-37, further comprising: receiving control signaling that indicates a corresponding value for each beam failure threshold of the set of one or more beam failure thresholds.
Aspect 39: The method of Aspect 38, wherein each corresponding value includes at least one of an absolute value for satisfying a corresponding beam failure threshold, or a value that is relative to the beam failure detection threshold satisfying the corresponding beam failure threshold.
Aspect 40: The method of any of Aspects 38-39, wherein the control signaling comprises radio resource control signaling.
Aspect 41: The method of any of Aspects 1-40, wherein the set of one or more beam failure thresholds includes the monitoring threshold and the beam failure detection threshold.
Aspect 42: The method of any of Aspects 1-41, wherein the monitoring threshold is different from the beam failure detection threshold.
Aspect 43: A method of wireless communication performed by a network node, comprising: transmitting, to a user equipment (UE), control signaling indicating a set of one or more pre-beam-failure actions; monitoring one or more signal quality parameters associated with communications via a communication beam; and performing an action of the set of one or more pre-beam-failure actions in association with a beam failure threshold, of a set of one or more beam failure thresholds, being satisfied, wherein a failure event counter associated with the communication beam being incremented from a first value that is less than or equal to a beam failure detection threshold to a second value that is greater than or equal to a monitoring threshold.
Aspect 44: The method of Aspect 43, wherein each beam failure threshold of the set of one or more beam failure thresholds is associated with at least one action of the set of one or more pre-beam-failure actions.
Aspect 45: The method of any of Aspects 43-44, wherein performing the action comprises: receiving, from the UE, a measurement report in association with the one or more signal quality parameters.
Aspect 46: The method of Aspect 45, wherein receiving the measurement report comprises: receiving at least one of uplink control information or a medium access control control element including the measurement report.
Aspect 47: The method of any of Aspects 45-46, wherein the measurement report is associated with at least one of the communication beam, a serving cell associated with the UE, or a candidate cell associated with the UE.
Aspect 48: The method of any of Aspects 45-47, wherein the measurement report comprises a channel status report that includes one or more of: a channel quality index, a rank indicator, a precoding matrix indicator, a layer 1 reference signal received power, or a layer 1 signal-to-interference plus noise ratio.
Aspect 49: The method of any of Aspects 45-48, wherein the measurement report comprises at least one of a beam measurement report or a cell measurement report, and the measurement report includes one or more of: a layer 3 reference signal received power, a layer 3 signal-to-interference plus noise ratio, or a reference signal received quality.
Aspect 50: The method of any of Aspects 43-49, wherein performing the action comprises: receiving, from the UE, an inference report.
Aspect 51: The method of Aspect 50, wherein the inference report comprises a layer 1 inference report including one or more of: predicted channel state information, or one or more beam parameter predictions.
Aspect 52: The method of any of Aspects 50-51, wherein the inference report comprises at least one of a layer 3 beam inference report, or a layer 3 cell inference report that includes one or more of: a predicted reference signal received power, a predicted signal-to-interference plus noise ratio, or a predicted reference signal received quality.
Aspect 53: The method of any of Aspects 43-52, wherein performing the action comprises: receiving, from the UE, a beam failure detection report.
Aspect 54: The method of Aspect 53, wherein receiving the beam failure detection report comprises: receiving a medium access control control element including the beam failure detection report.
Aspect 55: The method of any of Aspects 53-54, wherein the beam failure detection report includes one or more of: a value of the failure event counter, a value of an additional failure event counter, a confidence level associated with a predicted beam failure event, a probability that a predicted beam failure event associated with the communication beam is likely to occur, a timing of a predicted beam failure event associated with the communication beam, a measurement report for a serving cell associated with the UE, a measurement report for a neighboring cell associated with the UE, or a measurement report for a candidate cell associated with the UE.
Aspect 56: The method of any of Aspects 43-55, wherein performing the action comprises: performing, with the UE, a beam switching procedure associated with the beam failure threshold.
Aspect 57: The method of any of Aspects 43-56, wherein performing the action comprises: performing, with the UE, a cell switching procedure associated with the beam failure threshold.
Aspect 58: The method of Aspect 57, wherein the cell switching procedure includes at least one of a conditional handover procedure or a conditional lower layer triggered mobility cell switching procedure.
Aspect 59: The method of any of Aspects 43-58, wherein the beam failure threshold is associated with a non-zero probability that a beam failure event will occur during a subsequent quantity of time resources.
Aspect 60: The method of any of Aspects 43-59, wherein each beam failure threshold of the set of one or more beam failure thresholds is associated with at least one corresponding value that is less than the beam failure detection threshold and greater than or equal to the monitoring threshold.
Aspect 61: The method of any of Aspects 43-60, wherein the failure event counter includes a global beam failure event counter that is associated with a cumulative quantity of obtained beam failure instance indications within a duration of time.
Aspect 62: The method of any of Aspects 43-61, wherein the failure event counter includes a UE-specific beam failure event counter that is associated with a quantity of beam failure instance indications obtained between satisfying a first threshold and satisfying a second threshold.
Aspect 63: The method of any of Aspects 43-62, wherein performing the action in accordance with the second value satisfying the beam failure threshold is associated with the second value satisfying the beam failure threshold while a beam failure detection timer is active.
Aspect 64: The method of any of Aspects 43-63, wherein the first value is associated with a monitoring state of the UE, and the second value is associated with a beam failure warning state of the UE.
Aspect 65: The method of any of Aspects 43-63, wherein the first value is associated with a first beam failure warning state of the UE, and the second value is associated with a second beam failure warning state of the UE.
Aspect 66: The method of any of Aspects 43-63, wherein the first value and the second value are each associated with a beam failure warning state of the UE.
Aspect 67: The method of any of Aspects 43-63, wherein the first value is associated with a monitoring state of the UE, and the second value is associated with a beam failure detection state of the UE.
Aspect 68: The method of any of Aspects 43-67, further comprising: transmitting control signaling that indicates a corresponding value for each beam failure threshold of the set of one or more beam failure thresholds.
Aspect 69: The method of Aspect 68, wherein each corresponding value includes at least one of an absolute value for satisfying a corresponding beam failure threshold, or a value that is relative to the beam failure detection threshold satisfying the corresponding beam failure threshold.
Aspect 70: The method of any of Aspects 68-69, wherein the control signaling comprises radio resource control signaling.
Aspect 71: The method of any of Aspects 43-70, wherein the set of one or more beam failure thresholds includes the monitoring threshold and the beam failure detection threshold.
Aspect 72: The method of any of Aspects 43-71, wherein the monitoring threshold is different from the beam failure detection threshold.
Aspect 73: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-72.
Aspect 74: An apparatus for wireless communication at a device, the apparatus comprising one or more memories and one or more processors coupled to the one or more memories, the one or more processors configured to cause the device to perform the method of one or more of Aspects 1-72.
Aspect 75: An apparatus for wireless communication, the apparatus comprising at least one means for performing the method of one or more of Aspects 1-72.
Aspect 76: A non-transitory computer-readable medium storing code for wireless communication, the code comprising instructions executable by one or more processors to perform the method of one or more of Aspects 1-72.
Aspect 77: A non-transitory computer-readable medium storing a set of instructions for wireless communication, the set of instructions comprising one or more instructions that, when executed by one or more processors of a device, cause the device to perform the method of one or more of Aspects 1-72.
Aspect 78: A device for wireless communication, the device comprising a processing system that includes one or more processors and one or more memories coupled with the one or more processors, the processing system configured to cause the device to perform the method of one or more of Aspects 1-72.
Aspect 79: An apparatus for wireless communication at a device, the apparatus comprising one or more memories and one or more processors coupled to the one or more memories, the one or more processors individually or collectively configured to cause the device to perform the method of one or more of Aspects 1-72.
Aspect 80: A device comprising a processing system that includes one or more processors and one or more code-storing memories coupled with the one or more processors, the processing system configured to cause the device to perform the method of one or more of Aspects 1-72.
Aspect 81: A device comprising a processing system that includes processor circuitry and code-storing memory circuitry, the processing system configured to cause the device to perform the method of one or more of Aspects 1-72.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
monitor one or more signal quality parameters associated with communications via a communication beam;
obtain, in association with monitoring the one or more signal quality parameters, a beam failure instance indication associated with the communication beam;
increment, in accordance with obtaining the beam failure instance indication, a failure event counter from a first value to a second value, wherein the second value is less than or equal to a beam failure detection threshold and greater than or equal to a monitoring threshold; and
perform an action in accordance with the second value satisfying a beam failure threshold of a set of one or more beam failure thresholds.

2. The UE of claim 1, wherein each beam failure threshold of the set of one or more beam failure thresholds is associated with at least one action of a set of one or more pre-beam-failure actions.

3. The UE of claim 2, wherein the processing system is configured to cause the UE to:
receive control signaling indicating the set of one or more pre-beam-failure actions.

4. The UE of claim 1, wherein the processing system, to cause the UE to perform the action, is configured to cause the UE to:
transmit, to a network node, a measurement report in association with monitoring the one or more signal quality parameters.

5. The UE of claim 4, wherein the measurement report is associated with at least one or the communication beam, a serving cell associated with the UE, or a candidate cell associated with the UE.

6. The UE of claim 1, wherein the processing system, to cause the UE to perform the action, is configured to cause the UE to:
transmit, to a network node, an inference report.

7. The UE of claim 1, wherein the processing system, to cause the UE to perform the action, is configured to cause the UE to:
transmit, to a network node, a beam failure detection report.

8. The UE of claim 1, wherein the processing system, to cause the UE to perform the action, is configured to cause the UE to:
perform a beam switching procedure associated with the beam failure threshold.

9. The UE of claim 1, wherein the processing system, to cause the UE to perform the action, is configured to cause the UE to:
perform a cell switching procedure associated with the beam failure threshold.

10. The UE of claim 1, wherein the processing system, to cause the UE to perform the action, is configured to cause the UE to:
activate a beam failure prediction procedure using one or more of an artificial intelligence or machine learning (AI/ML) model or a historical data model.

11. The UE of claim 1, wherein each beam failure threshold of the set of one or more beam failure thresholds is associated with at least one corresponding value that is less than the beam failure detection threshold and greater than or equal to the monitoring threshold.

12. A network node, comprising:
a processing system that includes one or more processors and one or more code-storing memories coupled with the one or more processors, the processing system configured to cause the network node to:
transmit, to a user equipment (UE), control signaling indicating a set of one or more pre-beam-failure actions;
monitor one or more signal quality parameters associated with communications via a communication beam; and
perform an action of the set of one or more pre-beam-failure actions in association with a beam failure threshold, of a set of one or more beam failure thresholds, being satisfied, wherein a failure event counter associated with the communication beam being incremented from a first value that is less than or equal to a beam failure detection threshold to a second value that is greater than or equal to a monitoring threshold.

13. The network node of claim 12, wherein the processing system, to cause the network node to perform the action, is configured to cause the network node to:
receive, from the UE, a measurement report in association with the one or more signal quality parameters.

14. The network node of claim 12, wherein the processing system, to cause the network node to perform the action, is configured to cause the network node to:
receive, from the UE, an inference report.

15. The network node of claim 12, wherein the processing system, to cause the network node to perform the action, is configured to cause the network node to:
receive, from the UE, a beam failure detection report.

16. A method of wireless communication performed by a user equipment (UE), comprising:
monitoring one or more signal quality parameters associated with communications via a communication beam;
obtaining, in association with monitoring the one or more signal quality parameters, a beam failure instance indication associated with the communication beam;
incrementing, in accordance with obtaining the beam failure instance indication, a failure event counter from a first value to a second value, wherein the second value is less than or equal to a beam failure detection threshold and greater than or equal to a monitoring threshold; and
performing an action in accordance with the second value satisfying a beam failure threshold of a set of one or more beam failure thresholds.

17. The method of claim 16, wherein the failure event counter includes a global beam failure event counter that is associated with a cumulative quantity of obtained beam failure instance indications within a duration of time.

18. The method of claim 16, wherein the failure event counter includes a local beam failure event counter that is associated with a quantity of beam failure instance indications obtained between satisfying a first threshold and satisfying a second threshold.

19. The method of claim 18, comprising:
resetting the local beam failure event counter to zero in association with the beam failure threshold including the second threshold.

20. The method of claim 16, comprising:
incrementing, in accordance with obtaining the beam failure instance indication, an additional failure event counter, wherein the failure event counter is associated with a first set of beam failure parameters and the additional failure event counter is associated with a second set of beam failure parameters that is different than the first set of beam failure parameters.

21. The method of claim 20, wherein at least one of the first set of beam failure parameters or the second set of beam failure parameters includes one or more of:
a corresponding beam failure instance maximum count, or
a corresponding beam failure detection timer.

22. The method of claim 16, wherein performing the action in accordance with the second value satisfying the beam failure threshold is associated with the second value satisfying the beam failure threshold while a beam failure detection timer is active.

23. The method of claim 16, comprising:
generating, in accordance with monitoring the one or more signal quality parameters, a predicted beam failure event associated with the communication beam, wherein performing the action is associated with one or more characteristics of the predicted beam failure event satisfying a threshold.

24. The method of claim 16, comprising:
decrementing the failure event counter from the second value to a third value in association with at least one of a beam failure detection timer expiring, or one or more parameters associated with a predicted beam failure event satisfying a condition.

25. The method of claim 24, comprising:
performing an additional action in accordance with the third value satisfying an additional beam failure threshold of the set of one or more beam failure thresholds.

26. The method of claim 16, comprising:
receiving control signaling that indicates a corresponding value for each beam failure threshold of the set of one or more beam failure thresholds.

27. A method of wireless communication performed by a network node, comprising:
transmitting, to a user equipment (UE), control signaling indicating a set of one or more pre-beam-failure actions;
monitoring one or more signal quality parameters associated with communications via a communication beam; and
performing an action of the set of one or more pre-beam-failure actions in association with a beam failure threshold, of a set of one or more beam failure thresholds, being satisfied, wherein a failure event counter associated with the communication beam being incremented from a first value that is less than or equal to a beam failure detection threshold to a second value that is greater than or equal to a monitoring threshold.

28. The method of claim 27, wherein performing the action comprises:
performing, with the UE, a beam switching procedure associated with the beam failure threshold.

29. The method of claim 27, wherein performing the action comprises:
performing, with the UE, a cell switching procedure associated with the beam failure threshold.

30. The method of claim 27, comprising:
transmitting control signaling that indicates a corresponding value for each beam failure threshold of the set of one or more beam failure thresholds.
